(19) United States
(12) Patent Application Publication
(10) Pub. No.: US 2025/0332843 A1
(43) Pub. Date: Oct. 30, 2025

(54) LIQUID STIRRING APPARATUS, SYSTEM, AND CONTROL METHOD

(71) Applicant: CANON KABUSHIKI KAISHA, Tokyo (JP)

(72) Inventors: HIROMASA YONEYAMA, Kanagawa (JP); MASAKAZU NAGASHIMA, Kanagawa (JP); KOHEI FUKUI, Tokyo (JP); SHU KURIHARA, Tokyo (JP); YUJIRO ISHIDA, Tokyo (JP); RYOHEI MARUYAMA, Kanagawa (JP); KENTA IIMURA, Kanagawa (JP)

(21) Appl. No.: 19/185,120

(22) Filed: Apr. 21, 2025

(30) Foreign Application Priority Data
Apr. 26, 2024 (JP) 2024-072923

(51) Int. Cl. B41J 2/20; B41J 2/175

(52) U.S. Cl. CPC B41J 2/20; B41J 2/17596

(57) ABSTRACT

A liquid stirring apparatus comprises storage means for storing a liquid; and driving means for performing a rotation operation of rotating the storage unit. The rotation operation includes a stop operation of stopping rotation of the storage means at a plurality of stop positions. The plurality of stop positions include a first stop position at which a stop time is a first time, and a second stop position at which the stop time is a second time different from the first time.

### FIELD OF THE INVENTION

The present invention relates to a liquid stirring apparatus, a system, and a control method.

### DESCRIPTION OF THE RELATED ART

In some cases, a liquid containing a substance with sedimentability needs to stirred to dispersion a sediment at the time of use. For example, in a printing apparatus that performs printing by discharging liquid ink to a printing medium, when using ink such as pigment ink or metallic ink, the stirring may be needed to disperse a sediment. Japanese Patent Laid Open No. 5-338195 and Japanese Patent No. 6567186 each disclose an apparatus that stirs ink by rotating the storage portion of the ink.

However, it is sometimes impossible to efficiently stir the liquid if the storage portion of the liquid is simply rotated.

### SUMMARY OF THE INVENTION

The present invention provides a technique of more efficiently stirring a liquid.

According to an aspect of the present invention, there is provided a liquid stirring apparatus comprising: a storage unit configured to store a liquid; and a driving unit configured to perform a rotation operation of rotating the storage unit, wherein the rotation operation includes a stop operation of stopping rotation of the storage unit at a plurality of stop positions, and the plurality of stop positions include: a first stop position at which a stop time is a first time; and a second stop position at which the stop time is a second time different from the first time.

Further features of the present invention will become apparent from the

following description of exemplary embodiments (with reference to the attached drawings).

### BRIEF DESCRIPTION OF THE DRAWINGS

FIG. 1 is a perspective view of a system according to an embodiment of the present invention;

FIG. 2 is a front view of the system shown in FIG. 1;

FIG. 3 is an explanatory view of the internal structure of a liquid discharge apparatus;

FIG. 4 is a front view of a storage portion;

FIG. 5 is a perspective view of a liquid container and a container support unit;

FIG. 6 is an explanatory view showing the attachment form of the container support unit to the storage portion;

FIG. 7 is an operation explanatory view of a handle;

FIG. 8 is a perspective view of a liquid stirring apparatus;

FIG. 9 is a perspective view of the liquid stirring apparatus;

FIG. 10 is a front view of storage spaces;

FIG. 11 is a view showing the storage form of the container support unit;

FIG. 12 is a front view of the liquid stirring apparatus;

FIG. 13 is a perspective view of the rear portion of the liquid stirring apparatus;

FIG. 14 is a view showing an example of a stirring operation;

FIG. 15 is an explanatory view of a rotation regulating unit;

FIG. 16 is a view showing a rotation regulating form;

FIG. 17 is a view showing a rotation regulating form;

FIG. 18 is an explanatory view of a position detection operation;

FIG. 19 is an explanatory view of a channel forming member and a valve unit;

FIG. 20 is a view showing an example of a change of the posture of the channel forming member in rotation;

FIG. 21 is an explanatory view of the arrangement of tube fixing members on movable and fixed sides;

FIG. 22 is an explanatory view of a holding member;

FIG. 23 is a view showing an example of a change of the form of a tube or the like in rotation;

FIG. 24 is a block diagram of the control circuit of the system shown in FIG. 1;

FIG. 25 is an explanatory view of a control example;

FIG. 26 is an explanatory view of a control example;

FIG. 27 is an explanatory view of another example;

FIG. 28 is an explanatory view of another example;

FIG. 29 is an explanatory view of another example;

FIG. 30 is a view showing another example of the stirring operation;

FIG. 31 is a flowchart showing an example of processing of a control unit;

FIG. 32 is a flowchart showing an example of processing of the control unit;

FIG. 33 is a flowchart showing an example of processing of the control unit;

FIG. 34 is a flowchart showing an example of processing of the control unit;

FIG. 35 is a view showing another example of the stirring operation;

FIG. 36 is a flowchart showing an example of processing of a control unit;

FIG. 37 is a flowchart showing an example of processing of a control unit;

FIG. 38 is a flowchart showing an example of processing of the control unit;

FIG. 39 is a view showing an example of a stop time setting table;

FIG. 40 is a flowchart showing an example of processing of the control unit;

FIG. 41 is a flowchart showing an example of processing of the control unit; and

FIG. 42 is a flowchart showing an example of processing of the control unit.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

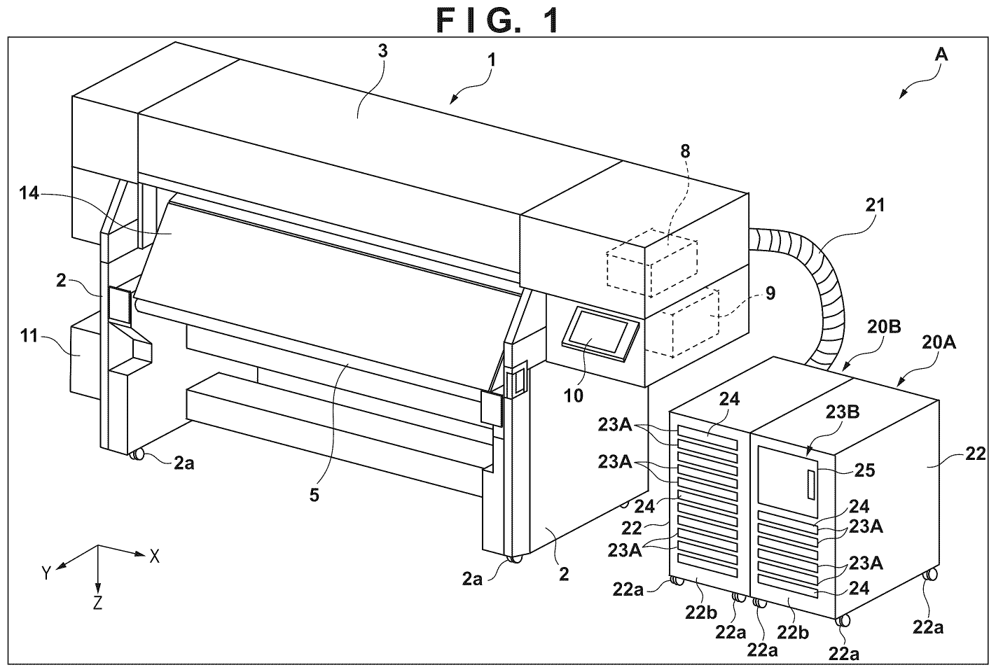

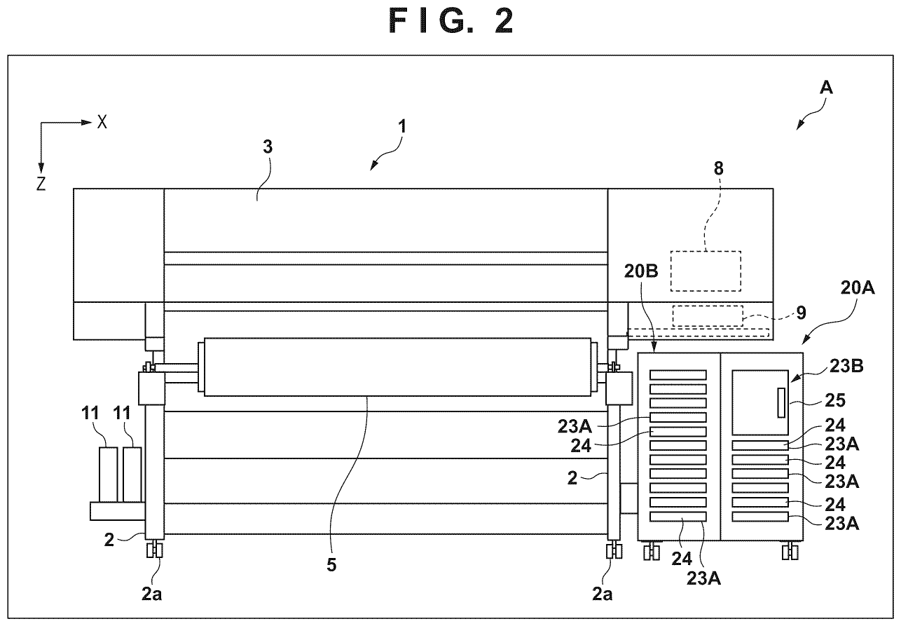

FIG. 1 is a perspective view of a system A according to an embodiment of the present invention, and FIG. 2 is a front view of the system A. In the drawings, arrows X, Y, and Z indicate directions crossing each other, and in this embodiment, the directions are orthogonal to each other. The left-right direction in a case where the system A is installed on a horizontal surface is the X direction, the front-back direction is the Y direction, and the upward-downward direction is the Z direction. The X direction and the Y direction can also be called the lateral directions.

The system A according to this embodiment is a printing system that includes a liquid discharge apparatus 1 and liquid storage apparatuses 20A and 20B and prints an image by discharging ink to a printing medium such as paper. In this embodiment, two liquid storage apparatuses 20A and 20B are provided. The liquid discharge apparatus 1 and the two liquid storage apparatuses 20A and 20B are arranged side by side in the X direction. A liquid that the liquid storage apparatuses 20A and 20B supply to the liquid discharge apparatus 1 is mainly ink, and the liquid discharge apparatus 1 is a printing apparatus that discharges the ink to the printing medium. However, the present invention is not limited to the printing system, and can also be applied to various kinds of liquid discharge systems aiming at discharging a liquid to a medium.

Note that “printing” is not limited to formation of significant information such as a character or figure, and includes, in a broad sense, to form an image, design, pattern, or the like on a printing medium or process a medium regardless of whether information is significant or insignificant, or whether information is so visualized as to allow a person to visually perceive it. Also, in this embodiment, the “printing medium” is assumed to be sheet-shaped paper but may be a cloth, a plastic film, or the like.

### Liquid Discharge Apparatus

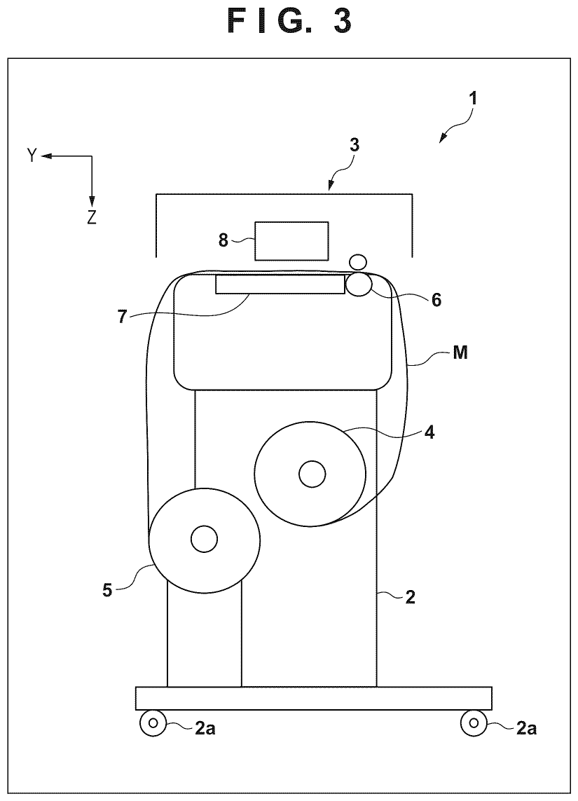

The liquid discharge apparatus 1 will be described with reference to FIG. 3 in addition to FIGS. 1 and 2. FIG. 3 is an explanatory view of the internal structure of the liquid discharge apparatus 1. The liquid discharge apparatus 1 includes a pair of left and right stands 2, and a main body 3 supported on the pair of stands 2. Each stand 2 is provided with casters 2a, and the liquid discharge apparatus 1 can be relatively easily moved on the floor. A feeding unit 4, a drying unit 14, and a winding unit 5 are arranged under the main body 3. In this embodiment, a printing medium M is roll paper, and the feeding unit 4 includes a shaft on which the printing medium M is wound. The winding unit 5 includes a shaft for winding up the printing medium M. In this embodiment, roll paper has been exemplified as the printing medium M, but it may be cut paper.

A conveyance unit 6 is provided in the main body 3. The conveyance unit 6 includes a driving roller and a driven roller, and the printing medium M fed from the feeding unit 4 is sandwiched in the nip portion between the rollers. When the driving roller rotates, the printing medium M is conveyed onto a platen 7. A discharge head 8 is arranged facing the platen 7. The discharge head 8 is a printhead that discharges ink to form an image. The discharge head 8 discharges the ink to the printing medium M conveyed onto the platen 7, thereby forming an image on the printing medium M.

The discharge head 8 includes, for example, a discharge energy generation element such as an electrothermal transducer (heater) or a piezoelectric element, and discharges ink from an orifice. If the electrothermal transducer is used, ink can be foamed by generated heat and discharged from the orifice using the foaming energy. The printing method of the discharge head 8 can be a serial scan method or a full-line method. In a case of the serial scan method, the discharge head 8 is mounted on a carriage and reciprocally moved in the X direction. Discharging ink while moving the discharge head 8 in the X direction is called print scanning. The conveyance operation of the printing medium M and print scanning of the discharge head 8 are alternately repeated, thereby printing an image on the printing medium M. In this embodiment, employment of the serial scan method is assumed. In a case of the full-line method, a long discharge head 8 extending in the X direction is used, and an image is printed while continuously conveying the printing medium M.

The printing medium M with the image printed thereon passes through the drying unit 14 and is then wound up by the winding unit 5. The drying unit 14 reduces liquid components contained in the ink applied, by the discharge head 8, to the printing medium M, thereby increasing the fixing properties between the printing medium M and the ink. The drying unit 14 includes a heat source such as a heater, and a blower mechanism such as a fan, and applies hot air at least from the ink application surface side to the passing printing medium M, thereby drying the printing medium M. Note that as for the drying method, not only the method of applying hot air but also a method of irradiating the surface of the printing medium M with an electromagnetic wave (ultraviolet rays or infrared rays) or a heat conduction method using contact of a heat generating body may be used in combination. In addition, the drying unit 14 may only blow air without having any heat source. The printing medium M with the image printed thereon is cut by a user using scissors or automatically cut by a cutter (not shown).

A recovery unit 9 is arranged in the main body 3. The recovery unit 9 is arranged outside the print region (outside the discharge region) of the discharge head 8, and performs processing associated with recovery and maintaining of the discharge performance of the discharge head 8. Examples of the processing are preliminary discharge of discharging a predetermined amount of ink before and after a printing operation and processing of sucking remaining ink or the like from the orifices of the discharge head 8. The discharge head 8 is moved onto the recovery unit 9, as shown in FIG. 2, if recovery processing is necessary.

An operation panel 10 is provided on the front surface of the main body 3. Also, the operation panel 10 is, for example, a touch panel and can accept input of various kinds of settings concerning printing and display the state of a print job. The liquid discharge apparatus 1 is also provided with a waste liquid cartridge 11. The waste liquid cartridge 11 is arranged under an end portion of the main body 3 on the opposite side of the liquid storage apparatuses 20A and 20B in the X direction.

A waste liquid (waste ink, or the like) sucked by the recovery unit 9 flows into the waste liquid cartridge 11 to be collected. The waste liquid cartridge 11 may be arranged near the recovery unit 9. In this embodiment, however, the waste liquid cartridge 11 is arranged in a free space under the end portion of the main body 3, thereby reducing the installation area of the liquid discharge apparatus 1.

### Liquid Storage Apparatus

FIGS. 1 and 2 will be referred to. The liquid storage apparatuses 20A and 20B are apparatuses that store a liquid such as ink to be discharged from the discharge head 8 and supply the liquid such as ink to the liquid discharge apparatus 1. The liquid storage apparatuses 20A and 20B each include a box-shaped main body 22 that forms a plurality of storage portions 23A and one storage portion 23B. Casters 22a are provided on the bottom surface of the main body 22, and the liquid storage apparatuses 20A and 20B can be relatively easily moved on the floor.

The liquid storage apparatuses 20A and 20B each include the plurality of storage portions 23A arrayed in the Z direction. Each storage portion 23A has a form of a slot opening to a front wall portion 22b of the main body 22. In each storage portion 23A, a container support unit 24 is detachably inserted in the Y direction. The container support unit 24 exchangeably supports a liquid container 200 (to be also simply referred to as a container 200) to be described later.

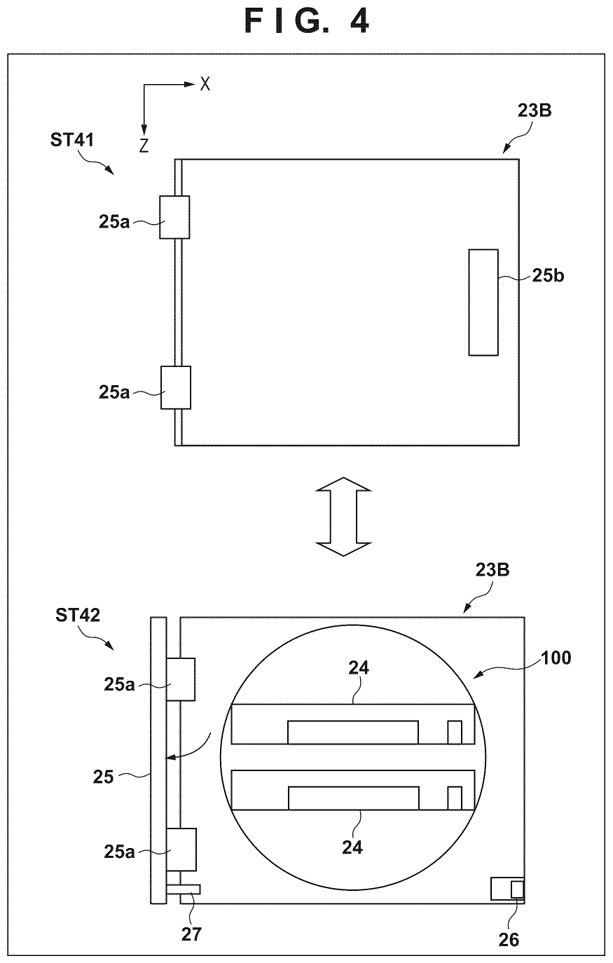

The liquid storage apparatus 20A includes the storage portion 23B. The storage portion 23B has a space larger than the storage portion 23A opening to the front wall portion 22b of the main body 22, and is opened/closed by an opening/closing member 25 provided on the front wall portion 22b. FIG. 4 is a front view of the storage portion 23B. A state ST41 indicates a state in which the opening/closing member 25 is closed, and a state ST42 indicates a state in which the opening/closing member 25 is open.

The opening/closing member 25 is a door whose one end portion in the X direction is supported by the front wall portion 22b via a plurality of hinges 25a, and a handle 25b that the user can grasp is provided at the other end portion in the X direction. If the user pulls the handle 25b to the near side from the state ST41, the opening/closing member 25 rotates about the hinges 25a serving as a rotation center, and the inside of the storage portion 23B is exposed, as shown in the state ST42. Note that in this embodiment, the opening/closing member 25 is of a rotation type but may be of a sliding type.

A sensor 26 that detects the open/closed state of the opening/closing member 25 is provided on the main body 22. The sensor 26 detects a detection piece 27 provided on the opening/closing member 25. The sensor 26 is, for example, an optical sensor and is arranged to detect the detection piece 27 in the closed state of the opening/closing member 25 and not to detect the detection piece 27 in the open state of the opening/closing member 25.

The storage portion 23B incorporates a liquid stirring apparatus 100. In the liquid stirring apparatus 100, a plurality of container support units 24 are detachably inserted in the Y direction. In this embodiment, two container support units 24 can be attached to the liquid stirring apparatus 100. The liquid stirring apparatus 100 has a function of stirring a liquid in the container 200 supported by each container support unit 24. Details of the liquid stirring apparatus 100 will be described later. Note that in this embodiment, the storage portions 23A and the storage portion 23B use common container support units 24 but may use different container support units.

Each of the storage portions 23A and 23B is provided with a tube that connects the container 200 and the liquid discharge apparatus 1. Each tube is connected to the liquid discharge apparatus 1 through a single hose 21 that stores all tubes. Ink in the container 200 is supplied to the discharge head 8 via the tube.

Since the two liquid storage apparatuses 20A and 20B are provided, the system A according to this embodiment can use more inks. When increasing the number of ink colors for the purpose of printing a high-quality image or increasing the amount of ink of the same color for the purpose of attaining high productivity, providing the plurality of liquid storage apparatuses 20A and 20B is advantageous.

### Liquid Container and Container Support Unit

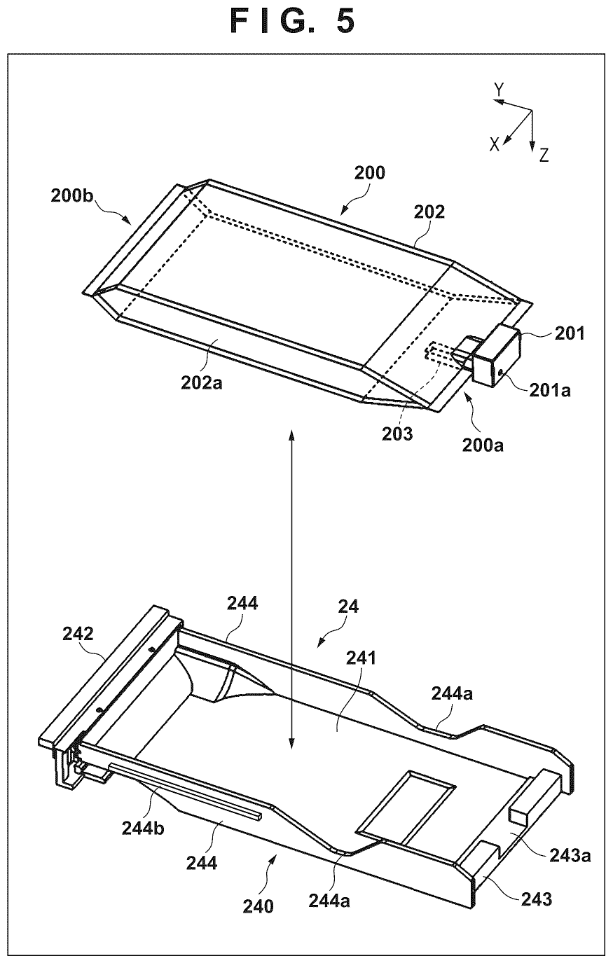

FIG. 5 is a perspective view of the container 200 and the container support unit 24. The container 200 includes a bag 202 made of a material with flexibility. Gusset portions 202a folded inside are provided on both side surfaces of the bag 202 to increase the liquid storage amount. The bag 202 is formed into a bag shape by welding sheets forming the upper and lower surfaces and sheets forming the gusset portions 202a to each other, thereby forming a flexible tank for storing a liquid. The shape of the bag 202 changes in accordance with the stored liquid amount such that if the liquid amount remaining inside is large, the gusset portions 202a expand, and if the liquid amount remaining inside is small, the gusset portions 202a are folded inside. The material of the bag 202 is, for example, a material having a multiple-layer structure such as PET. If the liquid inside has a property of reacting with air and sticking, or there is concern that the concentration or remaining amount changes due to evaporation, a layer material including an aluminum layer is advantageous as the material of the bag 202.

The container 200 has one end portion 200a and the other end portion 200b in the longitudinal direction. In an attached state to the liquid storage apparatuses 20A and 20B, the end portion 200a is located on the far side of the liquid storage apparatuses 20A and 20B, and the end portion 200b is located on the near side. An outlet member 201 is provided at the end portion 200a. In the outlet member 201, a supply port 201a communicating with an intake port 203 inside the bag 202 is formed. The liquid stored in the bag 202 flows to the outside via the intake port 203 and the supply port 201a. A spring biased-type supply port control valve that opens/closes the supply port 201a is provided in the outlet member 201. By the supply port control valve, the supply port 201a is normally maintained in the closed state.

In the container 200, the side provided with the outlet member 201 has a length of, for example, about 180 mm, and the side (side surface) orthogonal to this side has a length of, for example, about 400 mm. In the container 200, for example, about 1.5 L liquid is stored. Note that the side with the outlet member 201 may be not the short side but the long side. Also, the bag 202 may have not a rectangular shape but a square shape in a planar view.

The container support unit 24 includes a support portion 240 that supports the container 200, and has a form of a tray, as a whole, on which the container 200 in a lying posture is placed. The support portion 240 includes a placement surface 241 on which the container 200 is placed, and the four sides of the placement surface 241 are defined by left and right side plates 244, a front end portion 242, and a rear end portion 243. A notch portion 244a is formed in each side plate 244. A concave portion 243a on which the outlet member 201 is arranged is formed at the rear end portion 243. A rib 244b extending in the Y direction is provided on each side plate 244.

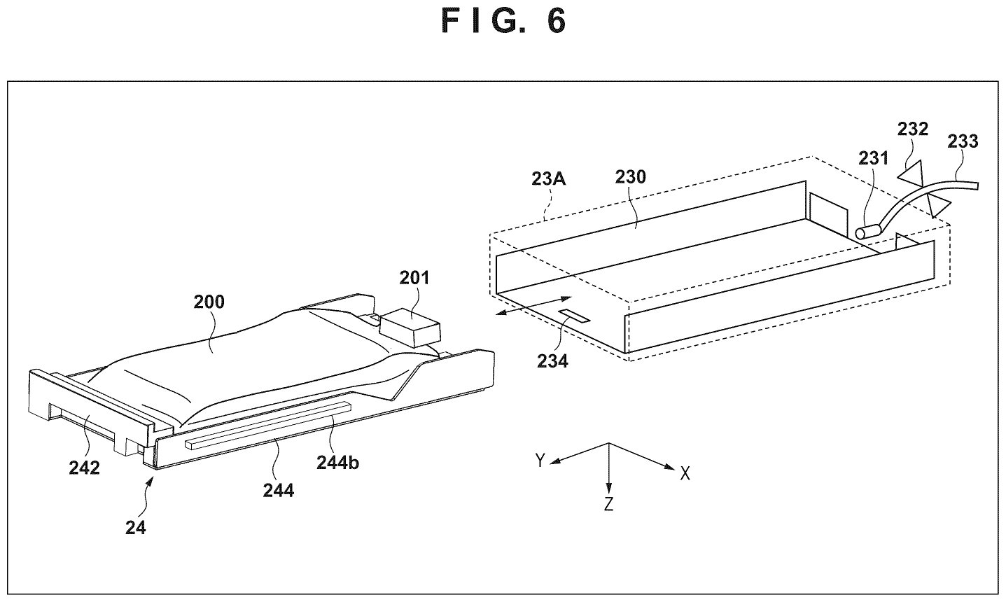

FIG. 6 will be referred to. FIG. 6 is an explanatory view showing the attachment form of the container support unit 24 to the storage portion 23A. Note that although the attachment form of the container support unit 24 to the storage portion 23A will be described here, the attachment form of the container support unit 24 to the liquid stirring apparatus 100 in the storage portion 23B is also substantially the same.

The storage portion 23A is provided with a case 230 that accepts the container support unit 24. The container support unit 24 can displace in the Y direction between a storage position where the container 200 is stored in the main body 22 and a take-out position where the container 200 is exposed to the outside of the main body 22. In FIG. 6, the container support unit 24 is located at the take-out position. At the take-out position, the container 200 can be exchanged. At the storage position, the container 200 is attached to the case 230.

Note that in this embodiment, at the take-out position, the container support unit 24 is apart from the storage portion 23A. However, the take-out position may be a position where the end portion of the container support unit 24 is held inside the storage portion 23A, and can be any position where the container 200 can be exchanged with respect to the container support unit 24.

On the far side of the case 230 in the Y direction, a needle member 231 to be inserted into the supply port 201a is provided. The needle member 231 is provided for each storage portion 23A. If the container support unit 24 is located at the storage position, the needle member 231 is inserted into the supply port 201a and connected. Thus, the supply port control valve inside the outlet member 201 is opened by the insertion of the needle member 231. The needle member 231 is connected to a tube 233. The needle member 231 and the tube 233 form a channel that flows the liquid stored in the bag 202 to the liquid discharge apparatus 1 that is the supply destination. An electrically driven channel valve 232 is provided on a midway part of the tube 233. The tube 233 can be closed and opened by opening/closing of the channel valve 232.

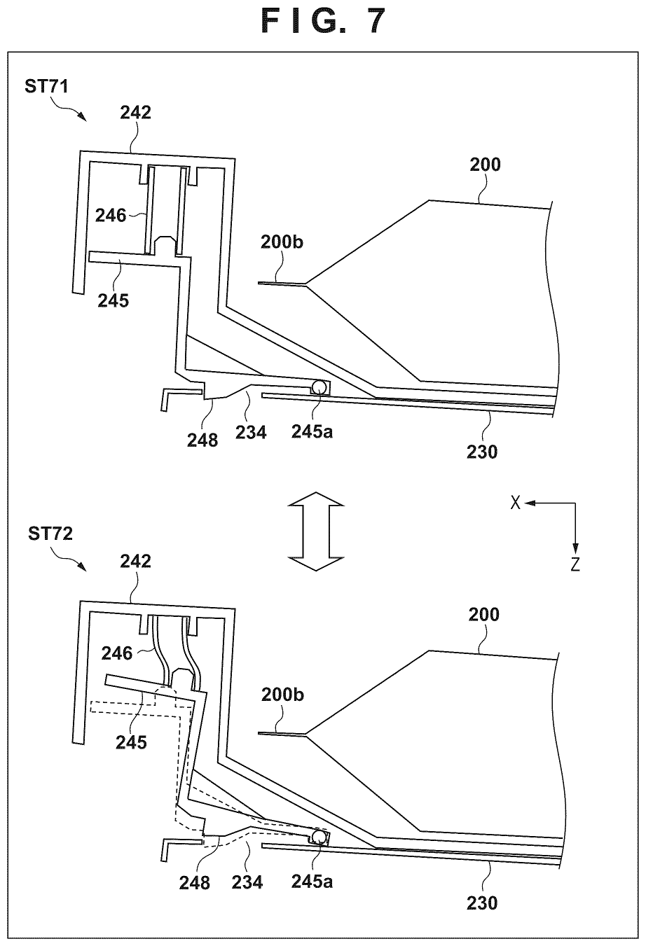

A mechanism that holds the container support unit 24 at the storage position will be described with reference to FIG. 7. FIG. 7 is an operation explanatory view of a handle provided on the container support unit 24. A state ST71 in FIG. 7 indicates a holding state, and a state ST72 indicates a holding cancel state.

At the front end portion 242 of the container support unit 24, a handle 245 that is rotatable about a shaft 245a extending in the X direction is provided, and the user can operate the handle 245. The handle 245 also serves as an operation handle of an engaging portion 248. The handle 245 is provided with the engaging portion 248, and an engaging portion 234 that engages with the engaging portion 248 is formed on the bottom portion of the case 230.

In this embodiment, the engaging portion 248 is a projecting portion, and the engaging portion 234 is a concave portion or hole portion in which the engaging portion 248 is inserted. When the engaging portion 248 and the engaging portion 234 engage with each other, the container support unit 24 can be prevented from dropping from the storage portion 23A even if a vibration acts on it due to, for example, movement of the liquid storage apparatus 20A.

The handle 245 is always biased, by an elastic member 246, to the side of the engaging position (the position in the state ST71 shown in FIG. 7) where the engaging portion 248 engages with the engaging portion 234. The elastic member 246 is, for example, a coil spring. When the user grasps the handle 245 and rotates it, the engaging portion 248 and the engaging portion 234 are disengaged, as indicated by the state ST72, and the container support unit 24 inserted into the storage portion 23A can be extracted from the storage portion 23A.

### Liquid Stirring Apparatus

Various kinds of liquids can be stored in the container 200 and used for image printing, maintenance of the discharge head 8, or the like. Depending on the type of ink, the color material (pigment component) in ink may be sedimented along with the elapse of time. For example, a pigment component of water-proof or lightfast pigment ink or a titanium oxide component used in white is not soluble in water and is therefore sedimented, deposited, and coagulated on the bottom portion of the container by gravity if it is left to stand for long time. Hence, to obtain required color development, it is necessary to evenly disperse the color developing component in the liquid while maintaining a predetermined particle size. In this embodiment, the liquid stirring apparatus 100 is provided, thereby stirring such a liquid to disperse particles and thus improve evenness. In particular, when stirring of the liquid is automated, burden on the user can be reduced.

### Outline of Apparatus

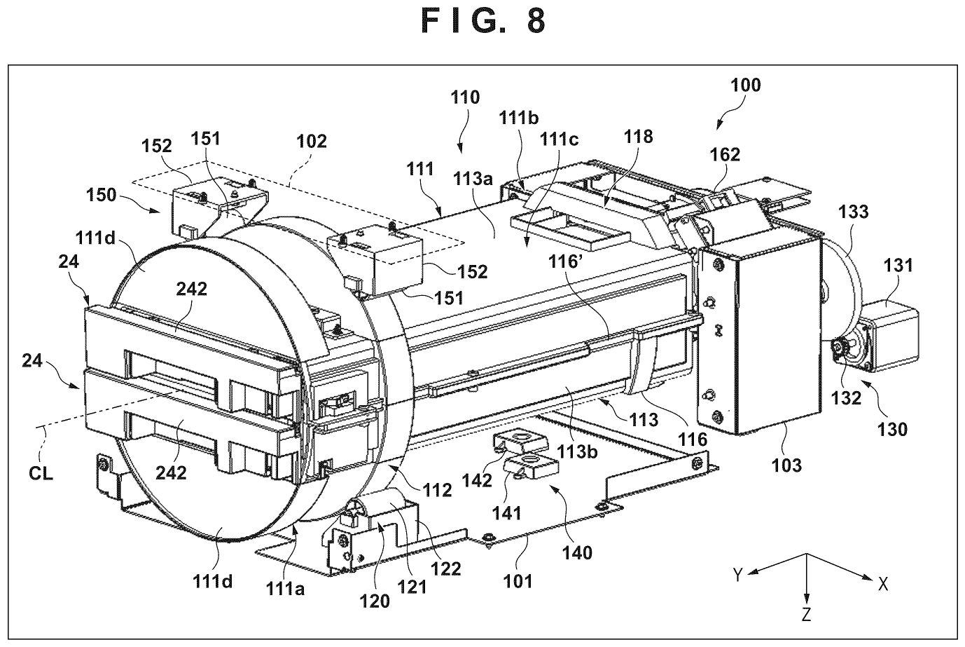

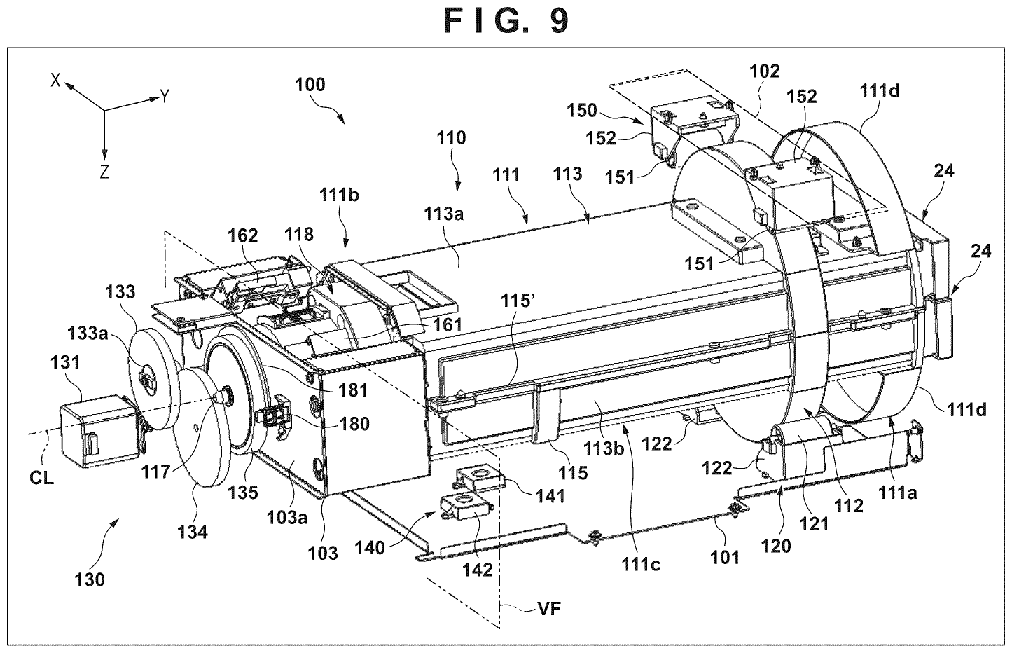

FIGS. 8 and 9 are perspective views of the liquid stirring apparatus 100. FIG. 8 is a perspective view of the liquid stirring apparatus 100 viewed from the front side, and FIG. 9 is a perspective view of the liquid stirring apparatus 100 viewed from the rear side.

The liquid stirring apparatus 100 includes a storage unit 110 that stores a liquid, a support unit 120 that rotatably supports the storage unit 110, and a driving unit 130 that rotates the storage unit 110 supported by the support unit 120. These components are supported by the main body 22 of the liquid storage apparatus 20A via frames including frames 101 to 103.

In this embodiment, the storage unit 110 is rotated about a rotational centerline CL indicated as a virtual line, thereby stirring the liquid stored in the storage unit 110. When the storage unit 110 is rotated, the liquid can be stirred more effectively. The rotational centerline CL is a line passing through the storage unit 110, and the direction is the Y direction in this embodiment.

In this embodiment, two container support units 24 are formed such that these can freely be inserted/extracted to/from the storage unit 110 from the front side of the storage unit 110. Thus, liquids in the two containers 200 can simultaneously be stirred. The two container support units 24 are attached to the storage unit 110 while overlapping as two, upper and lower stages. Note that the number of attachable container support units 24 may be three or more or may be one.

The driving unit 130 is arranged on the rear side of the storage unit 110, and a relatively wide space is ensured on the front side of the storage unit 110. This improves the insertion/extraction properties of the container support unit 24 for the user with respect to the storage unit 110. Also, since the liquid stirring apparatus 100 has a structure extending in the Y direction as a whole, the liquid stirring apparatus 100 can be made compact in the X direction.

### Storage Unit

FIGS. 8 and 9 will be referred to. The storage unit 110 includes a storage member 111 and a shaft fixing member 118, which are connected in the direction of the rotational centerline CL.

The storage member 111 is a hollow member that stores the container 200. The storage member 111 includes, in the direction of the rotational centerline CL (Y direction), a front end portion 111a that is one end portion, and a rear end portion 111b that is the other end portion. Between the front end portion 111a and the rear end portion 111b, an outer wall portion 111c of the storage member 111 is formed by a cylindrical tube-shaped portion 112 and a polygonal tube-shaped portion 113. The cylindrical tube-shaped portion 112 is formed on the side of the front end portion 111a with respect to the rear end portion 111b, and the polygonal tube-shaped portion 113 is formed on the side of the front end portion 111a and the side of the rear end portion 111b from the cylindrical tube-shaped portion 112. The cylindrical tube-shaped portion 112 forms a cylindrical outer peripheral surface. The polygonal tube-shaped portion 113 substantially has a rectangular tube shape. In front view of the liquid stirring apparatus 100, fan-shaped cover members 111d that cover the components on the rear side of the front end portion 111a are attached to the front end portion 111a.

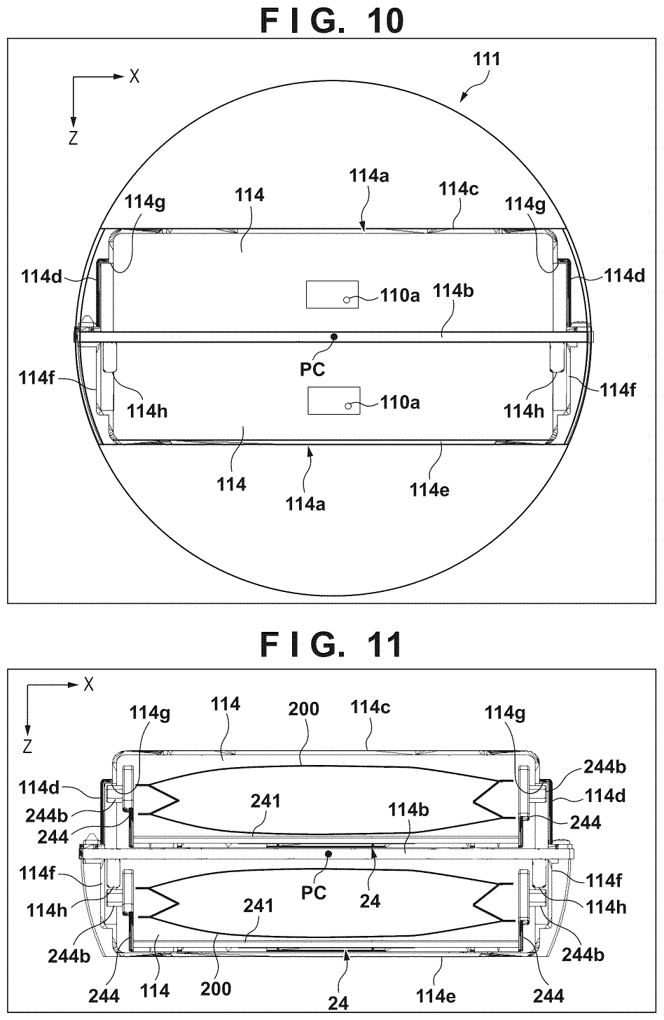

FIGS. 10 and 11 will be referred to, in addition to FIGS. 8 and 9. FIG. 10 is a front view of upper and lower storage spaces 114 formed by the storage member 111, and shows a state in which the container support units 24 are detached from the storage spaces 114. FIG. 11 is a front view of the upper and lower storage spaces 114, and particularly shows a form (sectional shape) in which the container support units 24 are stored in the storage spaces 114. The storage spaces 114 are formed throughout the cylindrical tube-shaped portion 112 and the polygonal tube-shaped portion 113. Note that matters concerning directions in the following explanation assume a case where the storage unit 110 is located at the initial position, unless it is specifically stated otherwise.

The internal space of the storage member 111 is divided into two, upper and lower stages by a partition wall 114b extending in the X and Y directions, and the storage spaces 114 along the rotational centerline CL are formed on the upper and lower sides of the partition wall 114b. At the front end portion 111a of the storage member 111, opening portions 114a serving as an exit and entrance of the storage spaces 114 open.

The container support unit 24 can displace in the Y direction between a storage position where the container 200 is stored in the storage space 114 and a take-out position where the container 200 is exposed to the outside of the storage unit 110. At the take-out position, the container 200 can be exchanged. Since the container 200 can be exchanged, a liquid replenishing work can quickly be performed, and the container support unit 24 can repetitively be used. Also, in this embodiment, since structures that obstruct the exchange work rarely exist near the opening portion 114a, the exchange workability of the container 200 is high.

Note that in this embodiment, at the take-out position, the container support unit 24 is apart from the storage space 114. However, the take-out position may be a position where the end portion of the container support unit 24 is held inside the storage space 114, and can be any position where the container 200 can be exchanged with respect to the container support unit 24.

The far side of the storage space 114 (a portion of the storage member 111 on the side of the end portion 111b) is closed, and a needle member 110a projects in the Y direction from the wall portion. When the container support unit 24 is inserted into the storage space 114, the needle member 110a is inserted into the supply port 201a of the container support unit 24. When the needle member 110a is inserted into the supply port 201a, a channel that flows the liquid stored in the bag 202 supported by the container support unit 24 to the liquid discharge apparatus 1 that is the supply destination is formed.

The storage space 114 according to this embodiment is a flat space having a cuboid shape, which extends in the Y direction and whose height in the Z direction is shorter than the width in the X direction. Note that the storage space 114 may be a flat space having a cuboid shape, which extends in the Y direction and whose height in the Z direction is longer than the width in the X direction.

The storage space 114 on the upper side is defined by a top wall 114c, left and right side walls 114d, and the partition wall 114b serving as a bottom wall, and the storage space 114 on the upper side is defined by a bottom wall 114e, the left and right side walls 114f, and the partition wall 114b serving as a top wall. The partition wall 114b serving as the bottom wall of the storage space 114 on the upper side and the bottom wall 114e of the storage space 114 on the lower side can be provided with engaging portions corresponding to the engaging portion 234 that holds the container support unit 24 at the storage position, as described with reference to FIG. 7.

A guide portion 114g is formed on each of the left and right side walls 114d of the storage space 114 on the upper side. The guide portion 114g has a sectional shape having a shoulder shape with a step or tilt, and extends in the Y direction. At the time of insertion/extraction of the container support unit 24 to/from the storage space 114, the guide portion 114g functions as a rail that comes into slidable contact with the rib 244b of the container support unit 24, and guides the displacement of the container support unit 24 in the insertion/extraction direction. In addition, the guide portion 114g abuts against the rib 244b in a direction (the Z direction at the initial position) crossing the direction of the rotational centerline CL, thereby regulating displacement of the container support unit 24 in the crossing direction. This can suppress looseness of the container support unit 24 in the storage space 114 at the time of rotation of the storage unit 110.

Similarly, a guide portion 114h is formed on each of the left and right side walls 114f of the storage space 114 on the lower side. The guide portion 114h has a convex shape projecting downward from the partition wall 114b, and extends in the Y direction. At the time of insertion/extraction of the container support unit 24 to/from the storage space 114, the guide portion 114h functions as a rail that comes into slidable contact with the rib 244b of the container support unit 24, and guides the displacement of the container support unit 24 in the insertion/extraction direction. In addition, the guide portion 114h abuts against the rib 244b in a direction (the Z direction at the initial position) crossing the direction of the rotational centerline CL, thereby regulating displacement of the container support unit 24 in the crossing direction. This can suppress looseness of the container support unit 24 in the storage space 114 at the time of rotation of the storage unit 110.

A rotation center PC of the storage unit 110 is located on the partition wall 114b. The rotation center PC is an arbitrary point on the rotational centerline CL. According to the configuration of this embodiment, since the rotational centerline CL passes between the two storage spaces 114, the liquids in the two containers 200 can be stirred more evenly by the storage unit 110.

### Rotation Support Structure

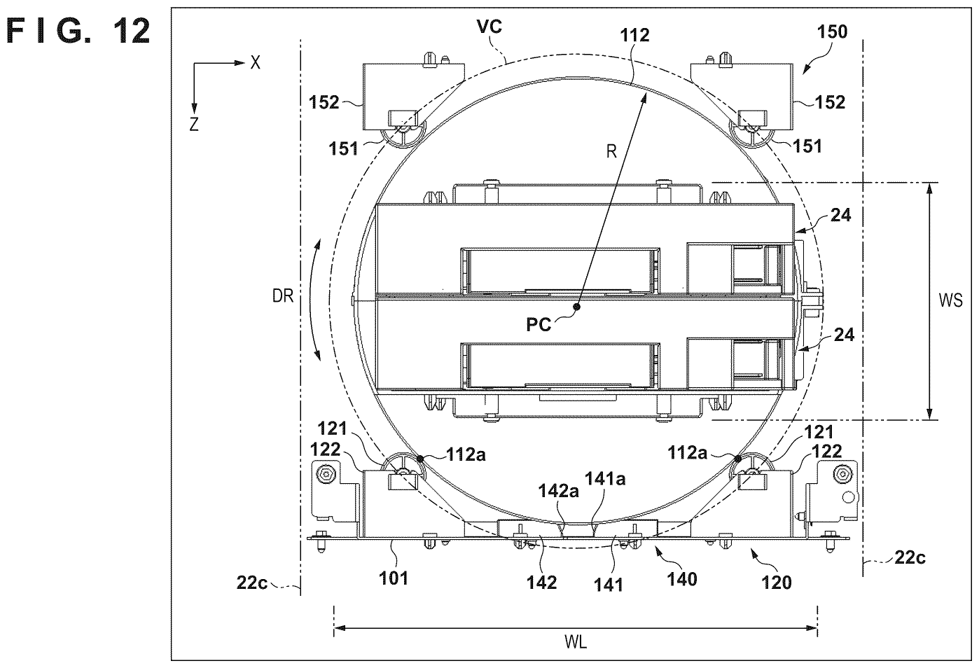

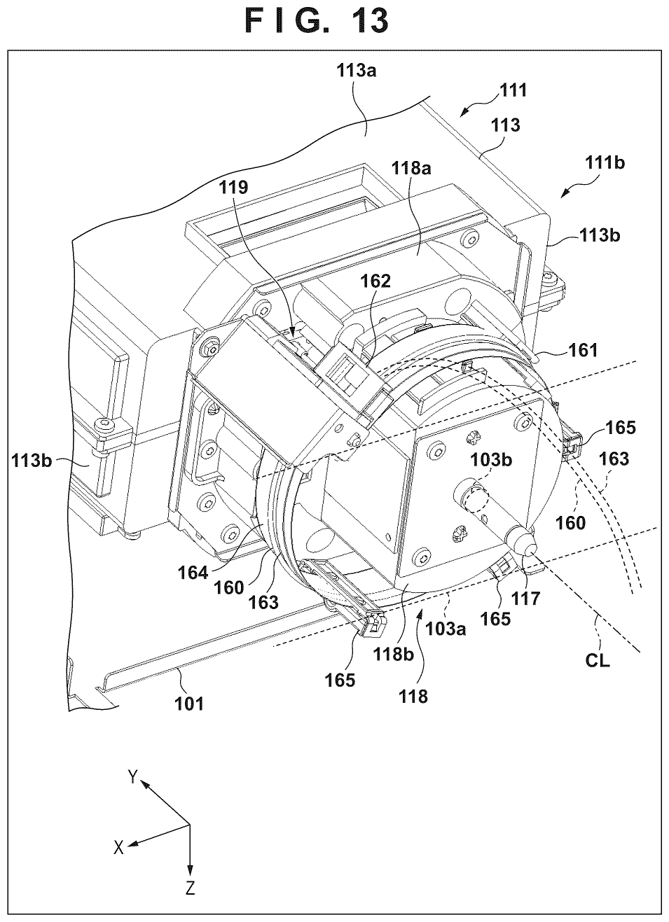

A structure that rotatably supports the storage unit 110 will be described with reference to FIGS. 8, 9, 12, and 13. FIG. 12 is a front view of the liquid stirring apparatus 100 and mainly shows the rotation support structure of the storage unit 110. FIG. 13 is a perspective view showing the rear portion of the storage unit 110 in a state in which the driving unit 130 is detached.

The problem of the structure that rotatably supports the storage unit 110 will be described. If the storage unit 110 includes a shaft between two end portions on the rotational centerline CL, the existence of the shaft and bearings may lower the degree of freedom of design or lower the convenience for the user. For example, in a structure in which the container support unit 24 is inserted/extracted into/from the storage unit 110, as in this embodiment, the insertion/extraction point or the insertion/extraction direction may be restricted. Also, in a structure in which a large capacity of liquid is stored and stirred, the rigidity of the shaft and the bearings need to be increased in consideration of the weight of the liquid.

In this embodiment, the problem is solved by combining the support unit 120 that is a shaftless support structure, and a support structure with shaft (a shaft member 117 and a bearing member 103a to be described later).

The support unit 120 is a mechanism that rotatably supports the storage unit 110 by abutting against the outer wall portion 111c of the storage unit 110. In the support unit 120 according to this embodiment, a plurality of abutment portions 121 abut against the cylindrical tube-shaped portion 112 of the storage member 111, thereby rotatably supporting the storage unit 110 about the rotational centerline CL. In this embodiment, the support unit 120 includes two abutment portions 121, and the two abutment portions 121 abut against the cylindrical tube-shaped portion 112 at abutment positions 112a apart in the circumferential direction of the cylindrical tube-shaped portion 112.

Each abutment portion 121 according to this embodiment is a roller that is supported by a bearing 122 about an axis in a direction (Y direction) parallel to the rotational centerline CL. The bearing 122 is supported by the frame 101. The peripheral surface of the abutment portion (roller) 121 abuts against the cylindrical tube-shaped portion 112, and the storage unit 110 can roll in the direction of an arrow DR in FIG. 12 in the spot in a state in which it is placed between the two abutment portions (rollers) 121. Since the storage unit 110 is supported from below by the two abutment portions 121, even if the storage unit 110 stores a large capacity of liquid, and the weight of the liquid is large, structural stability can be obtained without needing to greatly increase the rigidity.

The cylindrical tube-shaped portion 112 is formed on the side of the front end portion 111a with respect to the rear end portion 111b of the storage member 111, and the support unit 120 rotatably supports the storage unit 110 at a position on the side of the front end portion 111a with respect to the rear end portion 111b. The storage unit 110 is supported by the shaftless support unit 120 near the opening portions 114a serving as an exit and entrance to insert/extract the container support units 24 into/from the storage spaces 114. Since there is neither a shaft nor a bearing in the front portion of the liquid stirring apparatus 100, the convenience of the insertion/extraction work of the container support unit 24 by the user can be improved. Also, in the insertion/extraction work of the container support unit 24, a load in the gravity direction readily acts near the opening portions 114a in some cases. However, since the two abutment portions 121 support the storage unit 110 from below near the opening portions 114a, it is possible to stably receive the load.

In addition, since the storage member 111 has a structure including the cylindrical tube-shaped portion 112 and the polygonal tube-shaped portion 113, it is possible to reduce the weight and decrease the moment of inertia of rotation as compared to a case where the whole structure is formed by the cylindrical tube-shaped portion 112. The polygonal tube-shaped portion 113 includes long side portions 113a and short side portions 113b, which form the outline of the rectangle. In this embodiment, a width WL of the long side portion 113a, a width WS of the short side portion 113b, and a radius R of the cylindrical tube-shaped portion 112 hold relationships given by WL>WS, and WS<2×R. Since the width WS of the polygonal tube-shaped portion 113 is smaller than the diameter (2×R) of the cylindrical tube-shaped portion 112, it is possible to reduce the weight and decrease the moment of inertia of rotation.

On the other hand, a relationship given by WL>2×R holds, and the cylindrical tube-shaped portion 112 and the abutment positions 112a are located inside a virtual circle VC that passes through the outermost portion of the storage unit 110 and has the rotation center PC as the center. Hence, the liquid stirring apparatus 100 can be made compact. A side wall 22c of the storage portion 23B can be made closer to the storage unit 110, and the liquid stirring apparatus 100 can be made compact in the X direction.

The shaft member 117 is provided in the rear portion of the storage unit 110 (the side of the rear end portion 111b). The shaft member 117 is fixed at an end portion of the shaft fixing member 118 and extended on the rotational centerline CL. The shaft fixing member 118 is a hollow body including a flange portion 118a fixed to the rear end portion 111b of the storage member 111, and a trunk portion 118b extending backward from the flange portion 118a, and the shaft member 117 is fixed to the end portion of the trunk portion 118b. The frame 103 includes a plate-shaped bearing member 103a, and the shaft member 117 is inserted to a shaft hole 103b and supported. Since not only the support unit 120 but also the shaft member 117 and the bearing member 103a rotatably support the storage unit 110, a shift of the rotation center PC of the storage unit 110 can be prevented, and more stable rotation can be implemented. Since the shaft member 117 and the bearing member 103a are located on the opposite side of the storage unit 110 with respect to the opening portions 114a, the convenience of the insertion/extraction work of the container support unit 24 by the user is not deteriorated.

The liquid stirring apparatus 100 also includes a regulating unit 150 that regulates the displacement of the storage member 111 in a direction crossing the rotational centerline CL. The regulating unit 150 according to this embodiment regulates the displacement of the storage member 111 upward in the Z direction. When inserting/extracting the container support unit 24, if a force in an upward direction acts on the front side of the storage unit 110, and the posture tilts, a load in a bending direction acts on the shaft member 117. When the regulating unit 150 is provided, such a posture change can be prevented.

The regulating unit 150 according to this embodiment includes a plurality of abutment portions 151 that face the cylindrical tube-shaped portion 112 in the Z direction at positions on the upper side of the rotational centerline CL. If the storage member 111 is going to displace upward, the plurality of abutment portions 151 abut against the cylindrical tube-shaped portion 112 and physically stop the displacement. The plurality of abutment portions 151 may always abut against the cylindrical tube-shaped portion 112, or may located at positions slightly apart in the Z direction in a normal state.

In this embodiment, the regulating unit 150 includes two abutment portions 151, and the two abutment portions 151 are arranged apart in the circumferential direction of the cylindrical tube-shaped portion 112. Each abutment portion 151 according to this embodiment is a roller that is supported by a bearing 152 about an axis in a direction (Y direction) parallel to the rotational centerline CL. The bearing 152 is supported by the frame 102.

The X- and Y-direction positions of the two abutment portions 151 are the same as those of the two abutment portions 121 of the support unit 120. Same components can be used for the two sets of the abutment portions 151 and the bearings 152 and the two abutment portions 121 and the bearings 122 of the support unit 120. Component types can be reduced by sharing the components.

### Driving Unit

The structure of the driving unit 130 will be described with reference to FIGS. 8 and 9. The driving unit 130 is arranged on the outer side (rear side) of the rear end portion 111b of the storage member 111 in the direction of the rotational centerline CL. Since the driving unit 130 is arranged on the opposite side of the storage unit 110 with respect to the opening portions 114a, mechanisms existing around the opening portions 114a can be decreased, and the convenience of the insertion/extraction work of the container support unit 24 by the user can be improved.

The driving unit 130 includes a motor 131 as a driving source. The motor 131 is fixed to a frame (not shown). A gear 132 is attached to the output shaft of the motor 131. In this embodiment, the motor 131 is a step motor. The rotation amount of the storage unit 110 can be controlled by the rotation amount of the motor 131. The motor 131 may be a DC motor, and in this case, a rotation amount sensor such as a rotary encoder may be provided to control the rotation amount.

The driving unit 130 includes gears 133, 134, and 135. The gears 133 and 134 are rotatably supported by a frame (not shown). Each of the gears 133 and 134 is a two-stage gear, the gear 132 and the large gear of the gear 133 mesh with each other, and the large gear of the gear 134 meshes with the small gear of the gear 133. In addition, the gear 135 meshes with the small gear of the gear 134. Between the small gear and the large gear of the gear 133, a torque limiter 133a capable of blocking driving transmission between these is provided. By the torque limiter 133a, it is possible to prevent an overload from acting on the motor 131. Also, if the user erroneously touches the storage unit 110 during rotation of the storage unit 110, the torque limiter 133a blocks transmission of the driving force, and it is therefore possible to prevent a high load from acting on the user's hand.

The gear 135 is fixed to the shaft member 117. When the motor 131 is driven, the driving force is transmitted to the shaft member 117, and the storage unit 110 rotates. The bearing member 103a is located between the gear 135 and the shaft fixing member 118, and the storage unit 110 is positioned by these in the direction of the rotational centerline CL. Note that in this embodiment, a gear mechanism is used as the mechanism for transmitting the driving force from the motor 131 to the shaft member 117, but a transmission mechanism of another type such as a belt transmission mechanism may be used.

### Example of Stirring Operation

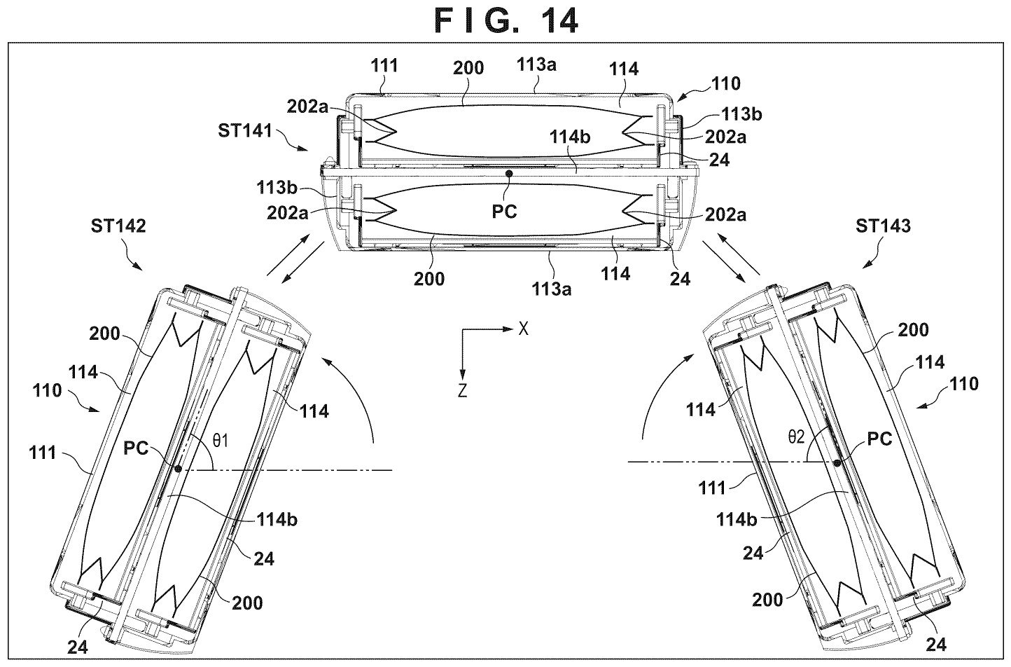

FIG. 14 shows an example of a stirring operation (the rotation operation of the storage unit 110) by driving of the driving unit 130. A state ST141 indicates a state in which the storage unit 110 is located at the initial position. At the initial position, the storage member 111 is in a horizontal posture with the long side portions 113a being horizontal. The support portion 240 of the container support unit 24 and the container 200 in each storage space 114 are also in the horizontal posture, and the gusset portions 202a on both sides of the container 200 are located at the same height.

A state ST142 indicates a tilting state in which the storage unit 110 rotates counterclockwise from the initial position by an angle θ1. The position of the storage unit 110 in this state is called a left tilting position. As for the gusset portions 202a on both side surfaces of the container 200, the gusset portion 202a on the right side in FIG. 14 is located at a position higher than that of the gusset portion 202a on the left side. The liquid in the container 200 flows from the side of the gusset portion 202a on the right side to the side of the gusset portion 202a on the left side.

A state ST143 indicates a tilting state in which the storage unit 110 rotates clockwise from the initial position by an angle θ2. The position of the storage unit 110 in this state is called a right tilting position. As for the gusset portions 202a on both side surfaces of the container 200, the gusset portion 202a on the left side in FIG. 14 is located at a position higher than that of the gusset portion 202a on the right side. The liquid in the container 200 flows from the side of the gusset portion 202a on the right side to the side of the gusset portion 202a on the left side.

When the posture of the storage unit 110 is repetitively changed as, for example, state ST141→state ST142→state ST141→state ST143→state ST141→ . . . , the liquid in the container 200 can be stirred.

When changing the posture of the storage unit 110 from the state ST142 to the state ST143, rotation may be temporarily stopped in the state ST141 halfway. Reversely, the posture of the storage unit 110 may continuously be changed from the state ST141 to the state ST143 without stopping rotation in the state ST141 halfway. This also applies to a case where the posture of the storage unit 110 is changed from the state ST143 to the state ST142.

Alternatively, between the state ST142 and the state ST143, without stopping rotation in the state ST141 halfway, the posture of the storage unit 110 may continuously be changed a plurality of times, and after that, rotation may be stopped for a predetermined time in the state ST141. This operation may repetitively be performed. While power consumption of the motor 131 is reduced by stopping rotation for a predetermined time in the state ST141, the rotation is resumed before sedimentation of the particles in the liquid progresses, thereby maintaining the evenness of the liquid.

The angle θ1 and the angle θ2 may be the same angle or may be different angles. The angle θ1 and the angle θ2 may be the same angle if the stirring operation is performed under a certain condition, and may be different angles if the stirring operation is performed under another condition. If the angle θ1 and the angle θ2 are different angles, the magnitude relationship may alternately be switched between θ1>θ2 and θ1<θ2.

If the angles θ1 and θ2 are too small, the stirring effect lowers. If the angles θ1 and θ2 are too large, the container 200 may twist. Hence, the angles θ1 and θ2 may be an angle selected from the range of, for example, 20° or more and less than 90°, or may be an angle selected from the range of 60° or more and 80° or less. As a specific angle, it may be, for example, 70°.

The angles θ1 and θ2 may be different angles depending on the condition to start the stirring operation. For example, under a condition that it is estimated that sedimentation is progressing, a larger angle may be used, and under a condition that it is estimated that sedimentation is not progressing, a smaller angle may be used.

In rotation control of the storage unit 110, the storage unit 110 is accelerated from a standstill state, rotated at a constant speed, and decelerated and stopped. As for the constant rotation speed (the rotation speed of the motor 131), if the speed is too high, a load may be applied to the container 200 too much, and if the speed is too low, stirring takes time. Hence, the constant rotation speed may be a speed selected from the range of, for example, 20 deg/sec or more and 160 deg/sec or less, or may be a speed selected from the range of, for example, 30 deg/sec or more and 140 deg/sec or less. The constant rotation speed and the angles θ1 and θ2 may have a relationship. For example, if the angles θ1 and θ2 are θα, the rotation speed may be set to V1. If the angles θ1 and θ2 are θβ larger than θα, the rotation speed may be set to V2 lower than 1V1. It is possible to simultaneously implement load reduction of the container 200 and fluidity of the liquid.

### Rotation Range Regulating Structure

If the storage unit 110 excessively rotates, a failure may occur in the driving system, or the tube for discharging the liquid twists and impedes the flow of the liquid. As a cause of the excessive rotation, for example, when the user inserts/extracts the container support unit 24 into/from the storage unit 110, he/she may erroneously rotate the storage unit 110 manually. The liquid stirring apparatus 100 according to this embodiment is provided with a structure that physically regulates the rotation range of the storage unit 110.

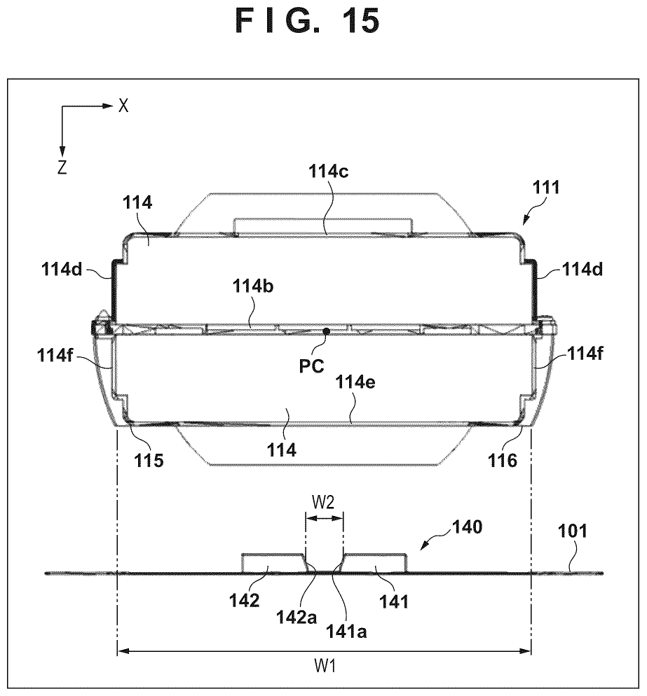

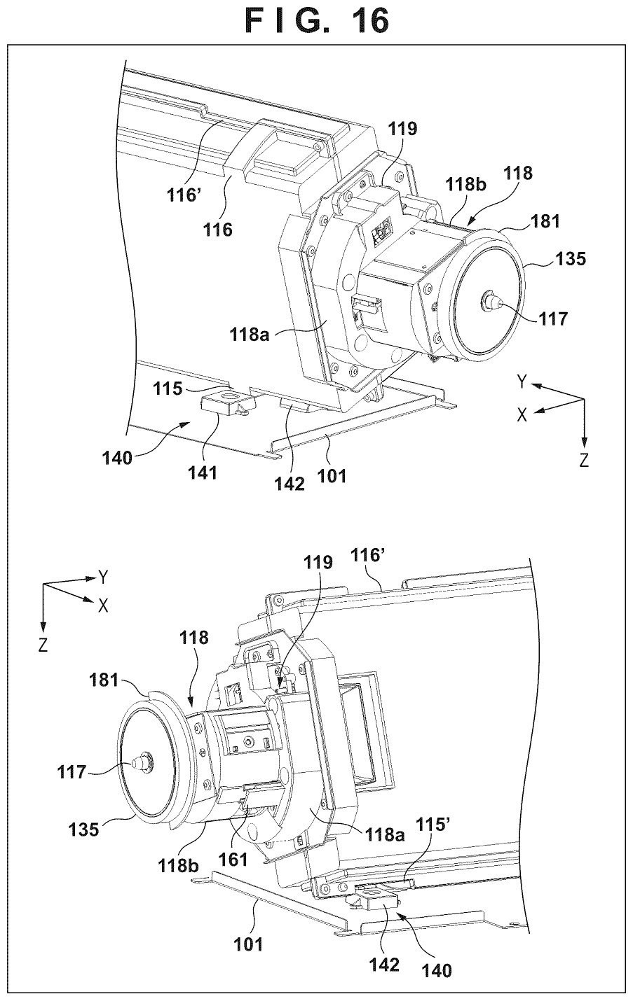

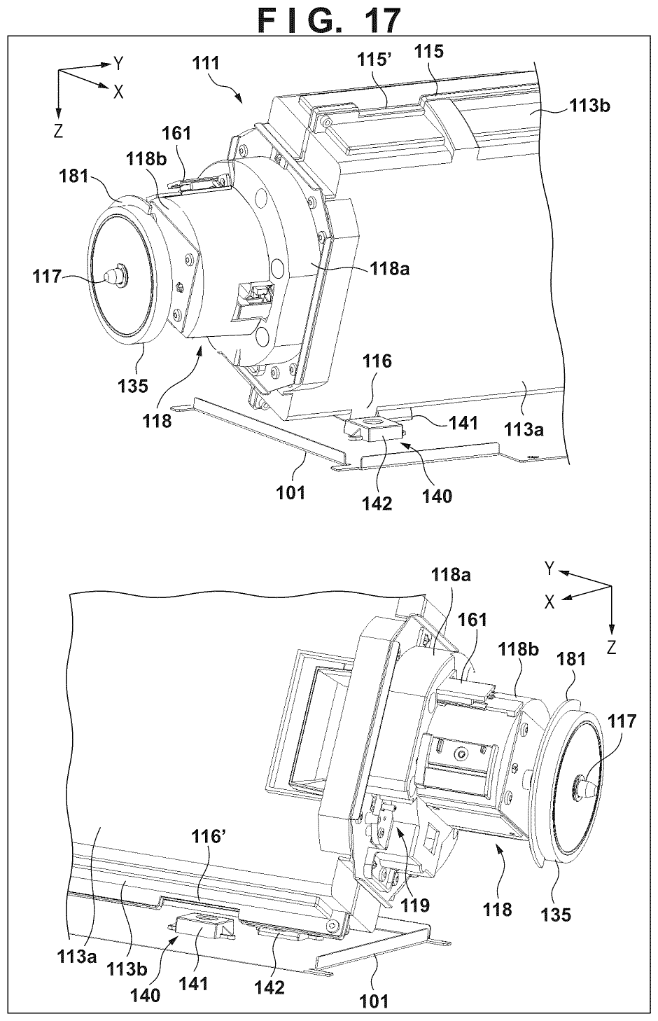

FIGS. 8, 9, 12, and 15 to 17 will be referred to. FIG. 15 is an explanatory view of a rotation regulating unit 140, and FIGS. 16 and 17 are views showing a rotation regulating form by the rotation regulating unit 140.

The liquid stirring apparatus 100 includes the rotation regulating unit 140 that regulates the rotation range of the storage unit 110. The rotation regulating unit 140 includes stoppers 141 and 142 that abut against the storage unit 110, thereby physically regulating the rotation of the storage unit 110. These can reliably prevent excessive rotation of the storage unit 110 by abutting against the storage unit 110 and directly regulating the rotation of the storage unit 110.

The stoppers 141 and 142 are block-shaped members fixed to the frame 101 and include tilting abutment surfaces 141a and 142a, respectively. The stopper 141 abuts against an abutment portion 115 formed on the outer wall portion 111c of the storage unit 110, thereby defining the upper limit of the range of rotation of the storage unit 110 in one direction (rotation from state ST141→state ST142 in FIG. 14). The stopper 142 abuts against an abutment portion 116 formed on the outer wall portion 111c of the storage unit 110, thereby defining the upper limit of the range of rotation of the storage unit 110 in the other direction (rotation from state ST141→state ST143 in FIG. 14). In this embodiment, the angles of the upper limit of the rotation range defined by the stoppers 141 and 142 are equal.

The abutment portions 115 and 116 are formed on the polygonal tube-shaped portion 113, particularly, not on the short side portions 113b but on the long side portion 113a. If the abutment portions project from the short side portions 113b, the diameter of the virtual circle VC exemplarily shown in FIG. 12 tends to be large due to their existence. This may make the liquid stirring apparatus 100 bulky in the X and Y directions. When the abutment portions 115 and 116 are formed on part of the long side portion 113a, the liquid stirring apparatus 100 can be made compact.

The abutment surfaces 141a and 142a of the stoppers 141 and 142 are located inside the virtual circle VC, as shown in FIG. 12. That is, the abutment positions between the stoppers 141 and 142 and the abutment portions 115 and 116 in the radial direction of the rotation of the storage unit 110 (the radial direction of the virtual circle VC) are located inside the virtual circle VC. The positions of the stoppers 141 and 142 in the X and Z directions can fall within a narrow range, and the liquid stirring apparatus 100 can be made compact in the X and Z directions.

As shown in FIG. 15, when viewed in the direction of the rotational centerline CL, with respect to the abutment positions as a reference, the abutment portion 115 and the abutment portion 116 are apart by a distance W1 in the X direction, and the stopper 141 and the stopper 142 are apart by a distance W2 in the X direction. The relationship is given by W1>W2. Since the disposition range of the stopper 141 and the stopper 142 in the X direction falls within the width of the storage member 111, the liquid stirring apparatus 100 can be made compact in the X direction.

Also, the abutment portions 115 and 116 are formed at end portions of the long side portion 113a in the X direction (boundaries to the short side portions 113b). Since these are located at positions relatively far from the rotation center PC, even if the rigidity of the stoppers 141 and 142 is relatively low, rotation of the storage unit 110 can be regulated more reliably.

The stopper 141 and the stopper 142 are arranged apart in the direction of the rotational centerline CL (Y direction). In correspondence with the arrangement of the stoppers 141 and 142, the abutment portions 115 and 116 are also arranged apart in the direction of the rotational centerline CL (Y direction). When the stopper 141 and the stopper 142 are arranged while being shifted in the direction of the rotational centerline CL, the separation distance between the stopper 141 and the stopper 142 in the X direction can be shortened even if the allowable rotation range of the storage unit 110 is large. This can make the liquid stirring apparatus 100 compact in the X direction.

FIG. 16 is a perspective view showing, from two directions, a state in which the stopper 141 abuts against the abutment portion 115, and rotation regulation of the storage unit 110 acts. When the abutment portion 115 abuts against the abutment surface 141a of the stopper 141, further rotation of the storage unit 110 is physically regulated. On the storage member 111, an interference avoiding portion 115′ is formed adjacent to the abutment portion 115. In this embodiment, the interference avoiding portion 115′ is a concave portion, and interference between the abutment portion 116 and the storage member 111 is avoided.

FIG. 17 is a perspective view showing, from two directions, a state in which the stopper 142 abuts against the abutment portion 116, and rotation regulation of the storage unit 110 acts. When the abutment portion 116 abuts against the abutment surface 142a of the stopper 142, further rotation of the storage unit 110 is physically regulated. On the storage member 111, an interference avoiding portion 116′ is formed adjacent to the abutment portion 116. In this embodiment, the interference avoiding portion 116′ is a concave portion, and interference between the abutment portion 115 and the storage member 111 is avoided.

Note that in this embodiment, the rotation range of the storage unit 110 is regulated by abutment between the stoppers 141 and 142 and the storage member 111. However, the rotation range may be regulated using another part. For example, the rotation range of the storage unit 110 may be regulated by making the stopper abut against the gear 133, the gear 134, or the gear 135 of the driving unit 130 to regulate rotation thereof.

### Rotation Position Detection

The user can touch the storage unit 110, and the position of the storage unit 110 sometimes deviates at the time of power-off of the liquid stirring apparatus 100. Also, in this embodiment, since the torque limiter 133a is provided in the driving transmission path of the driving unit 130, an error may occur between the rotation amount of the motor 131 and the rotation position of the storage unit 110. If the recognized error of the rotation position of the storage unit 110 is large, rotation control of the storage unit 110 may not correctly be performed in the stirring operation. In this embodiment, a sensor that detects the position of the storage unit 110 is provided, thereby improving the recognition accuracy of the rotation position of the storage unit 110.

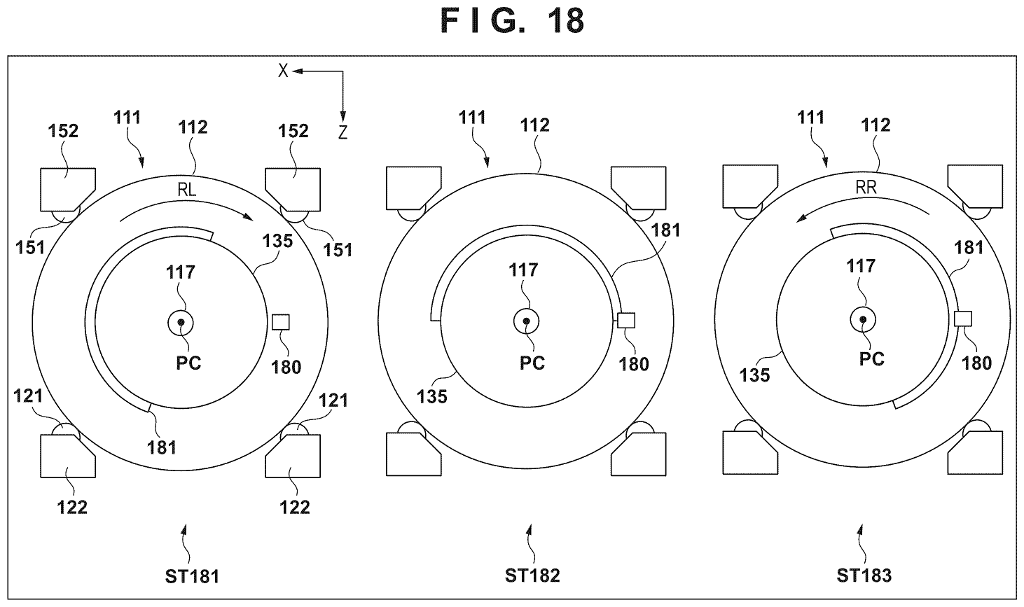

FIGS. 9, 16, 17, and 18 will be referred to. FIG. 18 is an explanatory view of an operation of detecting the position of the storage unit 110.

The storage unit 110 is provided with a detection piece 181 that rotates about the rotational centerline CL together with the storage unit 110. In this embodiment, the detection piece 181 is integrally formed on the gear 135 and fixed to the shaft member 117 using the gear 135. A sensor 180 that detects the detection piece 181 is fixed to the frame 103. The sensor 180 is, for example, an optical sensor, and detects whether the detection piece 181 exists at the detection position of the sensor 180. If the storage unit 110 is viewed from the rear side, the detection position is the 3 o'clock position, metaphorically speaking, on a clock face with the rotation center PC at the center (see FIG. 18).

The detection piece 181 includes a portion extended around the rotational centerline CL, and if the rotation position of the storage unit 110 is within a certain rotation range, the sensor 180 detects the detection piece 181. In this embodiment, the detection piece 181 has an arc shape (or a fan shape) with the rotational centerline CL as the center. Particularly, in this embodiment, the detection piece 181 has an arc shape corresponding to a semicircle.

In this embodiment, a position where the edge of the detection piece 181 cuts across the front of the sensor 180 (a position where the detection result changes from, for example, non-detection→detection) is defined as a reference position. In this embodiment, the reference position corresponds to the initial position of the storage unit 110 (the state ST141 in FIG. 14). A state ST182 shown in FIG. 18 indicates the positional relationship between the detection piece 181 and the sensor 180 in a case where the storage unit 110 is at the initial position.

The detection piece 181 is provided such that the detection piece 181 is detected by the sensor 180 during movement of the storage unit 110 from the initial position to the left tilting position indicated by the state ST142 in FIG. 14. A state ST183 shown in FIG. 18 indicates a position halfway through the rotation of the storage unit 110 from the initial position to the left tilting position in FIG. 14 (state ST142).

The detection piece 181 is provided such that the detection piece 181 is not detected by the sensor 180 during movement of the storage unit 110 from the initial position to the right tilting position indicated by the state ST143 in FIG. 14. A state ST181 shown in FIG. 18 indicates a position halfway through the rotation of the storage unit 110 from the initial position to the right tilting position in FIG. 14 (state ST143).

An example of processing using the detection result of the sensor 180 will be described. This processing can be executed by a control unit 32 to be described later. An example of initialization processing of rotating the storage unit 110 to the initial position will be described first with reference to FIG. 18. The initialization processing can be performed, for example, at the power-on of the liquid stirring apparatus 100. Also, the initialization processing can be performed, for example, periodically after the power-on of the liquid stirring apparatus 100.

In the initialization processing, the detection result of the sensor 180 is acquired first, and it is determined whether the detection piece 181 is detected. If the detection piece 181 is not detected, as exemplarily indicated by the state ST181 in FIG. 18, it can be discriminated that the storage unit 110 is located at a position where it is rotated from the initial position to the side of the right tilting position (the side of the state ST143 in FIG. 14). Hence, the storage unit 110 is rotated in the direction of an arrow RL by the driving unit 130, and the rotation of the storage unit 110 is stopped at a position where the detection result of the sensor 180 changes from non-detection→detection. The storage unit 110 is thus located at the initial position.

If the detection piece 181 is detected, as exemplarily indicated by the state ST183 in FIG. 18, it can be discriminated that the storage unit 110 is rotated to the side of the left tilting position from the initial position (the side of the state ST142 in FIG. 14). Hence, the storage unit 110 is rotated in the direction of an arrow RR by the driving unit 130. After passing a position where the detection result of the sensor 180 changes from detection→non-detection, the rotation direction of the storage unit 110 is reversed, and the storage unit 110 is stopped at a position where the detection result of the sensor 180 changes from non-detection→detection. The storage unit 110 is thus located at the initial position.

As described above, in this embodiment, by forming the shape of the detection piece 181 into a shape corresponding to the rotation position of the storage unit 110, it is possible to discriminate, based on the detection result of the sensor 180, in which rotation direction the storage unit 110 is rotated with respect to the initial position. As a result, the initialization processing can be completed quickly.

An example of rotation error processing of the storage unit 110 during the stirring operation will be described next. In the stirring operation shown in FIG. 14, every time the storage unit 110 passes the initial position (state ST141), the detection result of the sensor 180 switches from non-detection→detection or from detection→non-detection. If the detection result of the sensor 180 does not switch even if the rotation amount of the motor 131 reaches a predetermined amount, it can be determined that a foreign substance interferes with the driving unit 130 or the storage unit 110, and rotation is impossible.

Upon determining that rotation is impossible, processing such as stopping driving of the motor 131 or notification to the user can be performed as error processing. For example, the user is caused to power off the liquid discharge apparatus 1 or the liquid stirring apparatus 100 to do initialization processing by displaying a message via the operation panel 10 or a host computer 300 or by notifying the message by a voice or the like. Alternatively, the user can be guided to a service call by displaying an error code via the operation panel 10 or the host computer 300 or by notifying the error code by a voice or the like.

Note that in this embodiment, the detection piece 181 is integrally formed on the gear 135, but the part of the detection piece 181 is not limited to the gear 135. For example, the detection piece 181 may be provided on the storage member 111, for example, on the cylindrical tube-shaped portion 112.

### Liquid Discharge Structure

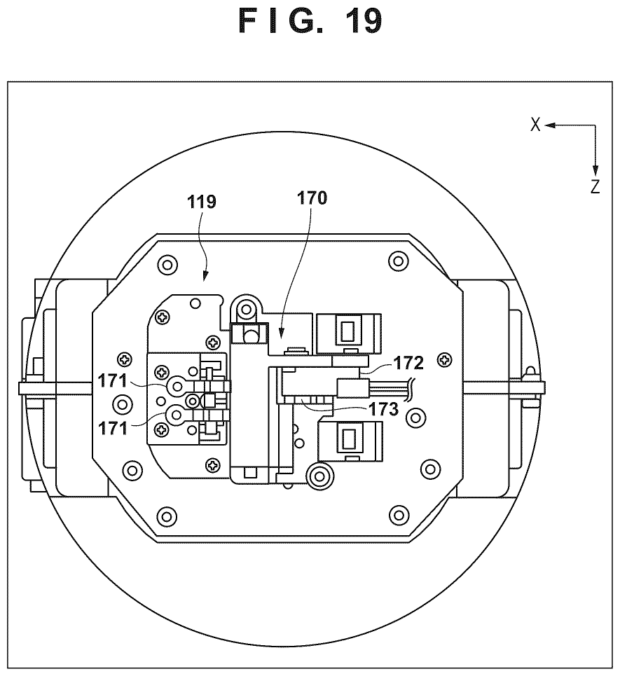

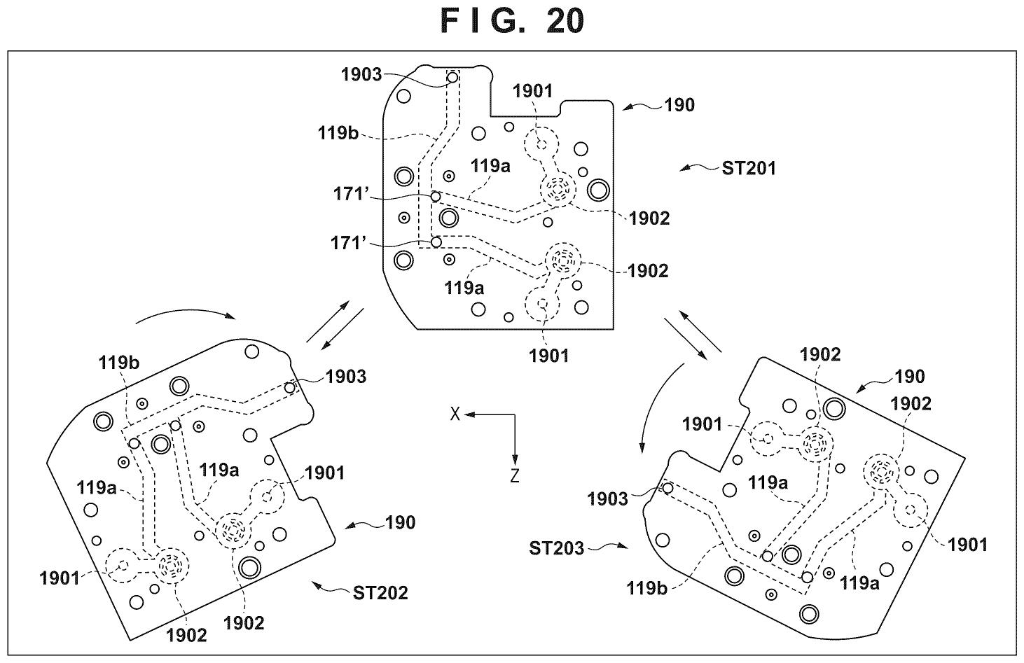

A structure configured to discharge a liquid from the container 200 via the needle member 110a will be described. Between the rear end portion 111b of the storage member 111 and the shaft fixing member 118, a channel forming member 119 is provided at the rear end portion 111b. FIG. 19 is a view showing the channel forming member 119 at the rear end portion 11b of the storage member 111 and a valve unit 170, and shows a state in which the shaft fixing member 118 is detached from the rear end portion 111b. FIG. 20 shows a channel formed by the channel forming member 119 and an example of a change of the posture of the channel forming member 119 associated with rotation of the storage unit 110.

First, FIG. 20 will be referred to. The channel forming member 119 forms a liquid channel 119b, and two liquid channels 119a branched from the channel 119b. An outlet hole 1903 is formed at an end portion of the channel 119b. Communicating holes 1901 that communicate with the needle members 110a of the storage spaces 114 of the two, upper and lower stages are formed at the end portions of the channels 119a. A check valve 1902 is formed on a midway part of each channel 119a. The liquid in the container 200 sequentially passes through needle member 110a→communicating hole 1901→channel 119a→channel 119b→outlet hole 1903 in this order and flows to the outside of the storage unit 110.

A state ST201 indicates the posture of the channel forming member 119 in a case where the storage unit 110 is at the initial position. A state ST202 indicates the posture of the channel forming member 119 in a case where the storage unit 110 is at the left tilting position (the state ST142 in FIG. 14). A state ST203 indicates the posture of the channel forming member 119 in a case where the storage unit 110 is at the right tilting position (the state ST143 in FIG. 14).

If the liquid stirring apparatus 100 does not operate for a long time in a state in which the storage unit 110 is at the initial position, particles contained in the liquid may be sedimented around the branching points between the channel 119b and the two channels 119a. In this embodiment, however, when the storage unit 110 rotates in the stirring operation, the channel forming member 119 also rotates, and its posture changes. Since the tilt of the channels 119a and 119b changes, the particles sedimented around the branching points readily flow together with the liquid, and it is possible to prevent the channels 119a and 119b from being closed by the particles.

The valve unit 170 shown in FIG. 19 is an electric valve that switches between closing and opening of the channels 119a at positions 171′ near the branching points between the channel 119b and the two channels 119a. The valve unit 170 includes two valve elements 171 corresponding to the two positions 171′, a motor 172 that is a driving source, and a position sensor 173 that detects the positions of the two valve elements 171. By the motor 172, the valve element 171 is driven by a cam mechanism (not shown) incorporated in the valve unit 170 to switch between closing and opening of the channel 119a.

By the valve unit 170, closing of both the two channels 119a and opening of one of these can be selected. For example, in a case where the containers 200 storing a liquid of the same type are stored in the storage spaces 114 of the two stages, the liquid is supplied from one container 200, and supply of the liquid from the other container 200 is stopped. If no liquid remains in the one container 200 anymore, the liquid is supplied from the other container 200, and the supply of the liquid from the one container 200 is stopped. After that, the one container 200 in which no liquid remains can be exchanged with a new container 200.

### Routing Structure of Tubes

A tube having flexibility is connected to the outlet hole 1903, and the liquid is supplied to the liquid discharge apparatus 1 via the tube. As shown in FIG. 20, the channel forming member 190 rotates along with the rotation of storage unit 110, and the position of the outlet hole 1903 changes. It is necessary to prevent the tube from twisting or causing an unintended behavior to contact peripheral structures and damage them in association with the position change. In this embodiment, a structure for controlling the behavior of the tube associated with the rotation of the storage unit 110 is employed, thereby solving the problem.

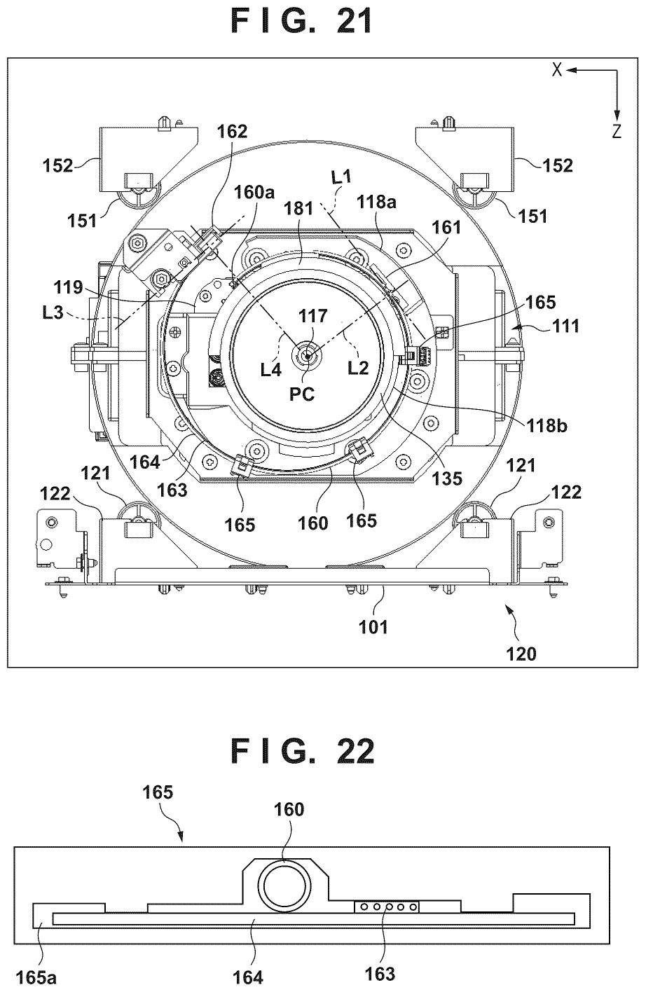

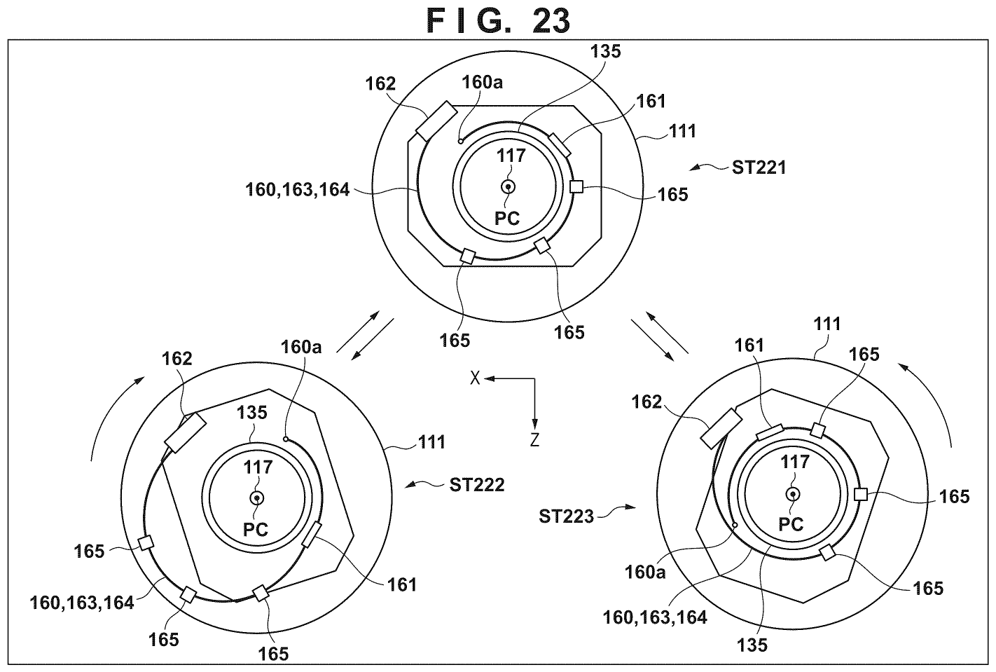

FIGS. 9, 13, 16, 17, and 21 to 23 will be referred to. FIG. 21 is a rear view showing the rear portion of the storage unit 110, and shows a state in which the driving unit 130 is detached except for the gear 135. FIG. 22 is an explanatory view of a holding member 165. FIG. 23 is a view showing an example of a change of the form of a tube 160 or the like at the time of rotation of the storage unit 110.

The tube 160 has an end portion 160a connected to the outlet hole 2903 and is extended from the storage unit 110. The tube 160 forms a discharge channel of the liquid discharged from the storage unit 110 (that is, the liquid in the container 200). A fixing member 161 is provided around the trunk portion 118b of the shaft fixing member 118. The fixing member 161 is a clip-type member that clamps the midway part of the tube 160, and fixes the midway part of the tube 160 to the storage unit 110. The fixing member 161 rotates about the rotational centerline CL together with the storage unit 110.

A fixing member 162 is provided on the frame 103. The fixing member 162 is a clip-type member that fixes the midway part of the tube 160 on the downstream side with respect to the fixing member 161 in the liquid flowing direction. The fixing member 162 is fixed to the frame 103 and is therefore an immobile member that does not rotate together with the storage unit 110. As shown in FIG. 9, the fixing members 161 and 162 are arranged on a virtual plane VF orthogonal to the rotational centerline CL. In this embodiment, the fixing members 161 and 162 are arranged on the common virtual plane. However, the virtual plane VF on which the fixing member 161 is arranged and the virtual plane VF on which the fixing member 162 is arranged may be shifted in the direction of the rotational centerline CL. In this case, the tube 160 may be arranged in a spiral shape extending in the direction of the rotational centerline CL.

If the storage unit 110 is at the initial position, as shown in FIG. 21, the fixing member 161 is located at the 2 o'clock position, and the fixing member 162 is located at the 10 o'clock position, metaphorically speaking, on a clock face with the rotation center PC at the center. The tube 160 passes on the upper side of the trunk portion 118b clockwise from the end portion 160a and reaches the fixing member 161, and further passes on the lower side of the trunk portion 118b clockwise and reaches the fixing member 162. The tube 160 is then further extended from the fixing member 162 (FIG. 13). As for the tube 160 shown in FIGS. 21 and 22, only the section from the end portion 160a to the fixing member 162 is shown. When viewed from the Y direction, the fixing member 161 and the fixing member 162 are arranged at least on the inner side of the cylindrical tube-shaped portion 112. Thus, the X-direction moving region of the tube 160 that rotates along with the rotation of the storage unit 110 can be made small.

The fixing member 161 fixes the midway part of the tube 160 to be directed in a tangent direction L1 rather than a radial direction L2 of the virtual circle on the X-Z plane with the rotation center PC serving as the center, and in this embodiment, the midway part is directed in the tangent direction L1. Similarly, the fixing member 162 fixes the midway part of the tube 160 to be directed in a tangent direction L3 rather than a radial direction L4 of the virtual circle on the X-Z plane with the rotation center PC serving as the center, and in this embodiment, the midway part is directed in the tangent direction L13. For this reason, in the tube section from the end portion 160a of the tube 160 to the fixing member 161 and in the tube section from the fixing member 161 to the fixing member 162, the tube 160 is routed in an arc shape or spiral shape around the rotational centerline CL. The fixing member 161 and the fixing member 162 are configured to fix the tube 160 substantially parallel to the tangent directions L1 and L3, respectively. Since the spreading direction of the tube 160 that rotates along with the rotation of the storage unit 110 can thus be guided to the gravity direction, and the load applied to the tube 160 is reduced, breakage of the tube 160 can be suppressed. Since this reduces the spread of the tube 160 in the X direction as well, the space to route the tube 160 can be made small in the X direction.

In this embodiment, in the tube section from the fixing member 161 to the fixing member 162, the tube 160 is routed together with an electric cable (for example, a flexible flat cable) 163 and a flexible band member 164.

The electric cable 163 includes, for example, wires of electric components provided in the storage unit 110, such as the electric wires of the motor 172 and the sensor 173. Like the tube 160, a midway part of the electric cable 163 is fixed by the fixing member 161, and a midway part on the downstream side is fixed by the fixing member 162. In the cable section from the fixing member 161 to the fixing member 162, the electric cable 163 is routed in an arc shape or spiral shape around the rotational centerline CL. The tube 160, the electric cable 163, the fixing member 161, and the fixing member 162 are disposed on the side of the rear end portion 111b with respect to the front end portion 111a of the storage member 111, particularly in this embodiment, on the rear side of the rear end portion 111b. These components do not hinder the insertion/extraction work of the container support unit 24 by the user on the side of the front end portion 111a, and the convenience for the user can be improved.

The band member 164 is, for example, a polyester film. The band member 164 supports the tube 160 and the electric cable 163, and the band member 164 that makes the behavior of the tube 160 and the electric cable 163 more stable at the time of the storage unit 110 is extended from the fixing member 161 to the fixing member 162.

To integrally route the tube 160 and the electric cable 163 together with the band member 164, a plurality of holding members 165 for holding these are used. The plurality of holding members 165 are binding members that are arranged in the section from the fixing member 161 to the fixing member 162 and integrally bind the tube 160, the electric cable 163, and the band member 164. FIG. 23 is an explanatory view showing the structure of the holding member 165, and the holding member 165 is configured to clamp, in a gap 165a, midway parts of the tube 160, the electric cable 163, and the band member 164. The holding members 165 can prevent the tube 160, the electric cable 163, and the band member 164 from separating from each other.

The behavior of the tube 160, the electric cable 163, and the band member 164 (to be referred to as the tube 160 and the like hereinafter) at the time of rotation of the storage unit 110 will be described with reference to FIG. 23. A state ST221 indicates a state in which the storage unit 110 is at the initial position. In the space from the fixing member 161 to the fixing member 162, the tube 160 and the like have an appropriate play or slack.

A state ST222 indicates the forms of the tube 160 and the like in a case where the storage unit 110 is at the left tilting position (the state ST142 in FIG. 14). In the state ST222, the length of the section between the fixing member 161 and the fixing member 162 in the clockwise direction in FIG. 23 is short, and these are close to each other, as compared to the state ST221. In the section from the fixing member 161 to the fixing member 162, the amount of the play or slack of the tube 160 and the like increases, and the radius of an arc drawn by the section becomes large.

A state ST223 indicates the forms of the tube 160 and the like in a case where the storage unit 110 is at the right tilting position (the state ST143 in FIG. 14). In the state ST223, the length of the section between the fixing member 161 and the fixing member 162 in the clockwise direction in FIG. 23 is long, and these are apart from each other, as compared to the state ST221. In the section from the fixing member 161 to the fixing member 162, the amount of the play or slack of the tube 160 and the like decreases, and the radius of an arc drawn by the section becomes small. The tube 160 and the like are close to the peripheral surface of the trunk portion 118b but not in contact, and the tube 160 and the like never contact the valve unit 170.

As described above, in this embodiment, a routing form in which the radius of the arc drawn by the tube 160 and the like changes depending on the direction of rotation of the storage unit 110 is employed, thereby controlling the behavior of the tube associated with the rotation of the storage unit 110. As a result, it is possible to prevent occurrence of twist or an unintended behavior of the tube 160 and the like.

### Control Circuit

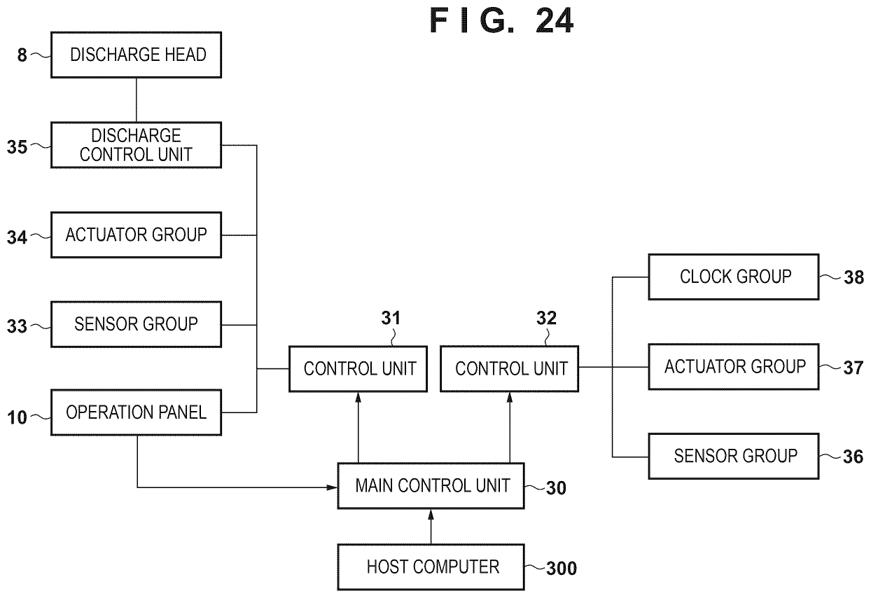

The configuration of the control circuit of the system A will be described with reference to FIG. 24. FIG. 24 is a block diagram of the control circuit of the system A. A main control unit 30 controls the entire system A in accordance with an instruction from the host computer 300 or the operation panel 10. A control unit 31 controls the liquid discharge apparatus 1 based on an instruction of the main control unit 30, and a control unit 32 controls the liquid storage apparatuses 20A and 20B based on an instruction of the main control unit 30. The main control unit 30 and the control units 31 and 32 each include, for example, at least one processor, at least one storage device, and at least one input/output interface. The storage device is, for example, a semiconductor memory such as a RAM or a ROM. The input/output interface performs input/output of signals between the processor and an external device (a sensor, a motor, or the like).

A discharge control unit 35 performs control of the discharge head 8, particularly, discharge control of the liquid. An actuator group 34 includes a conveyance motor that is the driving source of the conveyance unit 6, a carriage motor that is the driving source of the moving mechanism of a carriage (not shown), a winding motor that is the driving source of the winding unit 5, and a recovery motor that is the driving source of the recovery unit 9. The actuator group 34 further includes a cutter motor that is the driving source of a cutter (not shown) configured to cut the printing medium M after image printing. A sensor group 33 includes various kinds of sensors provided in the liquid discharge apparatus 1.

A clock portion 38 is a counter that outputs a count result of an elapsed time to the control unit 32. If a liquid stirring period is managed by time, the count result of the clock portion 38 can be used. Also, the stirring timing can be decided using the count result of the clock portion 38.

An actuator group 37 includes the motors 131 and 172, the channel valve 232, and the like provided in the liquid stirring apparatus 100. A sensor group 36 includes the sensors 26 and 180, and the like provided in the liquid stirring apparatus 100.

### Example of Processing of Control Circuit

An example of processing executed by the control unit 32 concerning the stirring operation will be described. A stirring operation using the rotation regulating unit 140 will be described here. The rotation regulating unit 140 is a structure that physically regulates the rotation range of the storage unit 110, as described above. On the other hand, it is possible to improve the liquid stirring effect by intentionally making the abutment portions 115 and 116 collide against the stoppers 141 and 142 to apply an impact to the storage unit 110. However, when the abutment portions 115 and 116 collide against the stoppers 141 and 142, striking sound may be generated. Hence, operation conditions are defined in advance, and one of the following rotation operations in which the rotation range of the storage unit 110 is different is executed in accordance with the presence/absence of satisfaction of an operation condition.

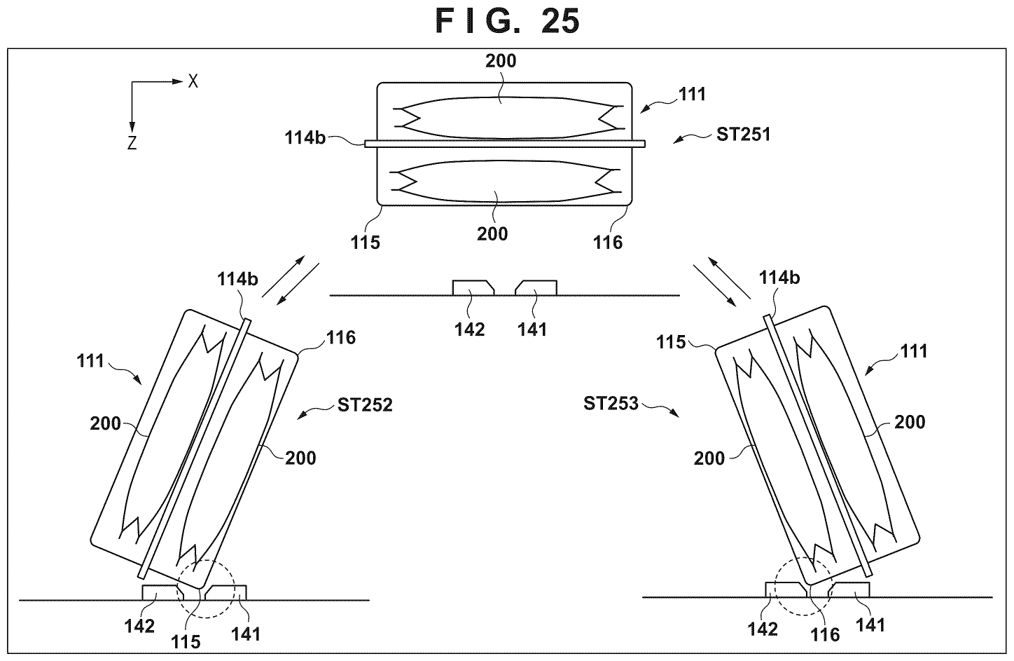

FIG. 25 shows an example of the rotation operation of the storage unit 110 in a case where a normal stirring effect is generated. A state ST251 indicates a state in which the storage unit 110 is at the initial position. A state ST252 indicates a state in which the storage unit 110 is rotated to the left tilting position. At this time, the rotation direction of the storage unit 110 is switched to the reverse direction before the abutment portion 115 abuts against the stopper 141. As an example, the rotation amount of the motor 131 is controlled such that the rotation of the storage unit 110 stops before the abutment portion 115 abuts against the stopper 141, and after that, the motor 131 is rotated in the reverse direction. Since the abutment portion 115 does not abut against the stopper 141, generation of striking sound can be prevented.

A state ST253 indicates a state in which the storage unit 110 is rotated to the right tilting position. Similarly, the rotation direction of the storage unit 110 is switched to the reverse direction before the abutment portion 116 abuts against the stopper 142. As an example, the rotation amount of the motor 131 is controlled such that the rotation of the storage unit 110 stops before the abutment portion 116 abuts against the stopper 142, and after that, the motor 131 is rotated in the reverse direction. Since the abutment portion 116 does not abut against the stopper 142, generation of striking sound can be prevented.

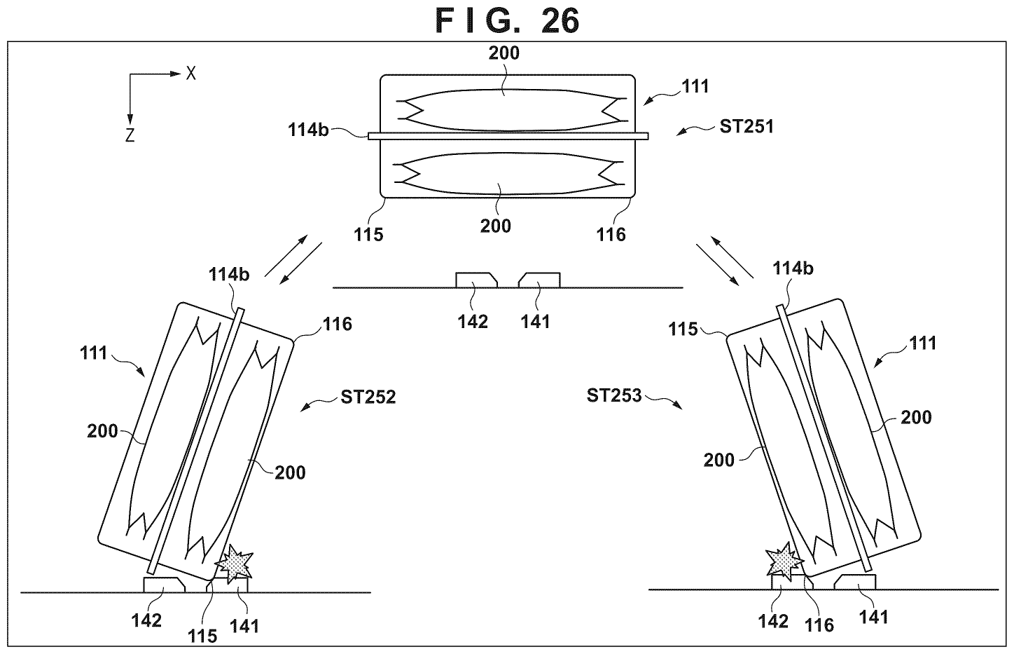

FIG. 26 shows an example of the rotation operation of the storage unit 110 in a case where a high stirring effect is generated. This rotation operation is executed when, for example, the system A is powered on, when the liquid stirring apparatus 100 is powered on, when the container 200 is exchanged, or when the container 200 stored standstill for a long time is used.

A state ST261 indicates a state in which the storage unit 110 is at the initial position. A state ST262 indicates a state in which the storage unit 110 is rotated to the left tilting position. At this time, the rotation direction of the storage unit 110 is switched to the reverse direction after the abutment portion 115 abuts against the stopper 141. As an example, the rotation amount of the motor 131 is controlled such that the rotation of the storage unit 110 continues until the abutment portion 115 abuts against the stopper 141, and after that, the motor 131 is stopped and rotated in the reverse direction. Since the abutment portion 115 abuts against the stopper 141, an impact acts on the storage unit 110, and the stirring performance of the liquid in the container 200 improves. Even if the impact acts on the storage unit 110, transmission of the impact to the motor 131 is blocked by the torque limiter 133a and, therefore, the influence on the driving system can be suppressed.

A state ST263 indicates a state in which the storage unit 110 is rotated to the right tilting position. Similarly, the rotation direction of the storage unit 110 is switched to the reverse direction after the abutment portion 116 abuts against the stopper 142. As an example, the rotation amount of the motor 131 is controlled such that the rotation of the storage unit 110 continues until the abutment portion 116 abuts against the stopper 142, and after that, the motor 131 is stopped and rotated in the reverse direction. Since the abutment portion 116 abuts against the stopper 142, an impact acts on the storage unit 110, and the stirring performance of the liquid in the container 200 improves.

Note that in the rotation operation shown in FIG. 26, control may be performed such that an impact acts only at the tilting position on one side. More specifically, at the left tilting position, the rotation direction of the storage unit 110 is switched to the reverse direction after the abutment portion 115 abuts against the stopper 141. However, at the right tilting position, the rotation direction of the storage unit 110 is switched to the reverse direction before the abutment portion 116 abuts against the stopper 142 to prevent the abutment portion 116 from abutting against the stopper 142.

As a reverse pattern, at the right tilting position, the rotation direction of the storage unit 110 is switched to the reverse direction after the abutment portion 116 abuts against the stopper 142. However, at the left tilting position, the rotation direction of the storage unit 110 is switched to the reverse direction before the abutment portion 115 abuts against the stopper 141 to prevent the abutment portion 115 from abutting against the stopper 141.

When performing control such that an impact acts only at the tilting position on one side, the combination of the abutment portion and the stopper to be caused to collide may be changed under a predetermined condition. For example, if the rotation operation of causing the abutment portion 115 to abut against the stopper 141 is performed a predetermined number of times, the combination of the abutment portion and the stopper to be caused to collide is changed to the abutment portion 116 and the stopper 142. Also, if the rotation operation of causing the abutment portion 116 to abut against the stopper 142 is performed a predetermined number of times, the combination of the abutment portion and the stopper to be caused to collide is changed again to the abutment portion 115 and the stopper 141. The condition for changing the combination may be not the count of the rotation operation but the time or period of the rotation operation.

### Second Embodiment

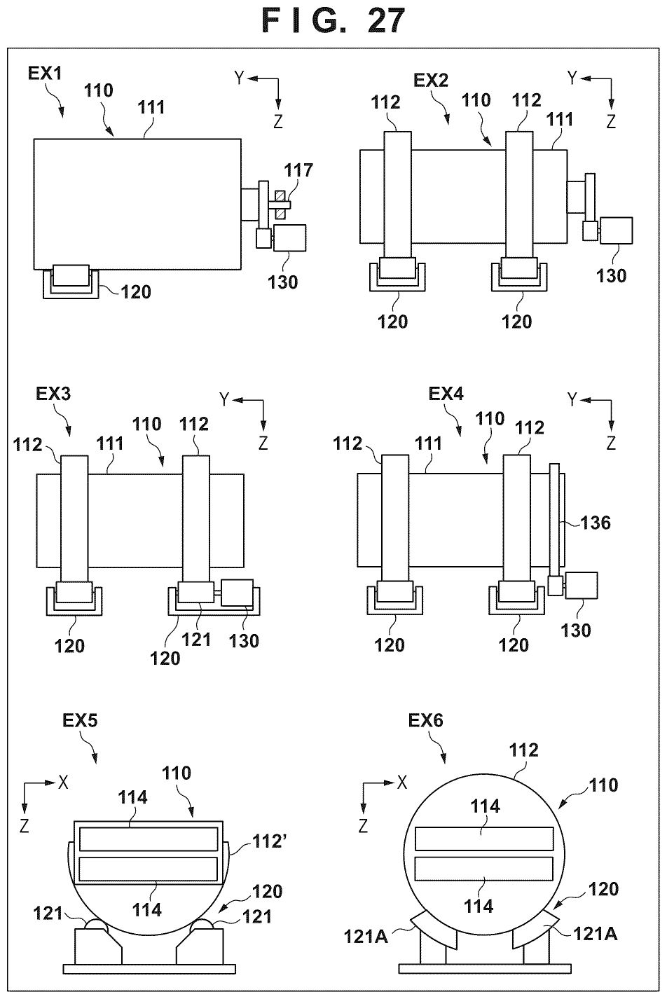

Another example of the configuration of a liquid stirring apparatus 100 will be described with reference to FIGS. 27 to 29.

In the storage member 111 according to the first embodiment, the outer wall portion 111c includes the cylindrical tube-shaped portion 112 and the polygonal tube-shaped portion 113. However, like a configuration example EX1 shown in FIG. 27, the whole outer wall portion of a storage member 111 may have a cylindrical tube shape.

Next, in the first embodiment, an example has been exemplified, in which as the rotation support structure of the storage unit 110, the support unit 120 that is a shaftless support structure, and a support structure with shaft (the shaft member 117 and the bearing member 103a) are combined. However, a storage unit 110 may rotatably be supported only by the shaftless support structure. A configuration example EX2 in FIG. 27 shows an example, and two sets of cylindrical tube-shaped portions 112 and support units 120 are provided apart in the direction of a rotational centerline CL, thereby supporting the storage unit 110. This can obviate the necessity of a shaft member 117 and a bearing member 103a.

In the configuration in which the storage unit 110 is rotatably supported only by the shaftless support structure, as in this example, like a configuration example EX3 shown in FIG. 27, a driving unit 130 may be configured to rotate the abutment portions 121 (rollers) and thus rotate the storage unit 110. Alternatively, like a configuration example EX4 shown in FIG. 27, the driving unit 130 may include a gear 136 fixed to the periphery of the storage member 111, and the storage unit 110 may be rotated by transmitting the driving force to the gear 136.

Next, in the first embodiment, the cylindrical tube-shaped portion 112 throughout the periphery of the storage member 111 in the circumferential direction is provided, and the cylindrical tube-shaped portion 112 is supported by the support unit 120. The part that the support unit 120 abuts against need only be the rotation range of the storage unit 110. For example, like a configuration example EX5 shown in FIG. 27, an arc-shaped portion 112′ may be provided in place of the cylindrical tube-shaped portion 112, and the abutment portions 121 of the support unit 120 may abut against the peripheral surface of the arc-shaped portion 112′.

Next, in the first embodiment, the abutment portion 121 of the support unit 120 is formed as a roller. However, it may be not a member that rolls, like a roller, but a member that comes into slidable contact with the storage member 111. A configuration example EX6 in FIG. 27 shows an example. An abutment portion 121A replacing the abutment portion 121 is a member having a curved surface with which the cylindrical tube-shaped portion 112 comes into slidable contact, and does not roll.

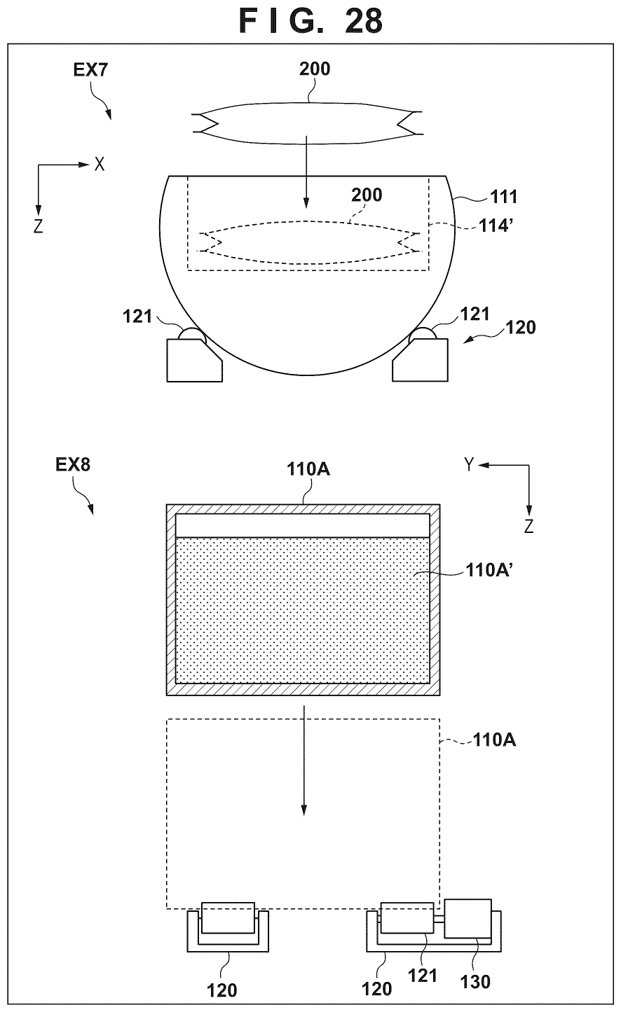

Next, in the first embodiment, the opening portion 114a of the storage space 114 opens to the front end portion 111a of the storage member 111 in the direction of the rotational centerline CL. However, the opening portion may open in a direction crossing the rotational centerline CL. For example, in a configuration example EX7 shown in FIG. 28, a storage space 114′ replacing the storage space 114 opens upward. A container 200 (or the container 200 and a container support unit 24) is inserted/extracted in the vertical direction with respect to the storage space 114′.

Next, in the first embodiment, the container 200 can be exchanged in the storage unit 110. However, the storage unit 110 may be a liquid tank equivalent to the container 200. A configuration example EX8 in FIG. 28 shows an example, and a storage unit 110A itself forms a liquid tank. In the configuration example EX8, the storage unit 110A is rotatably supported using only the shaftless support unit 120 as the support unit 120, like the configuration example EX3 shown in FIG. 27. Hence, if no liquid remains any more, exchange is performed by a unit of the storage unit 110A.

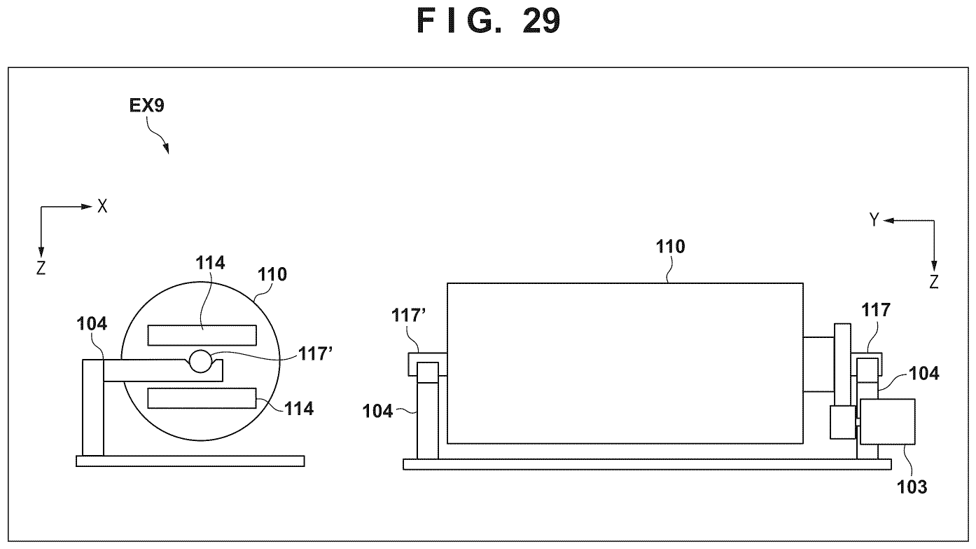

Next, in the first embodiment, an example has been exemplified, in which as the rotation support structure of the storage unit 110, the support unit 120 that is a shaftless support structure, and a support structure with shaft (the shaft member 117 and the bearing member 103a) are combined. However, the storage unit 110 may rotatably be supported only by the support structure with shaft. A configuration example EX9 in FIG. 29 shows an example. The storage unit 110 includes not only the shaft 117 at the rear end but also a shaft 117′ at the front end, and these are axially supported by bearings 104. The bearing 104 is a component that supports the shaft 117 or 117′ by a beam portion extending horizontally. When the storage unit 110 is at the initial position, the beam portion and the shaft 117′ are located between the storage spaces 114 of the two stages. These are configured not to greatly impede insertion/extraction of the container support unit 24 to/from the storage space 114.

### Third Embodiment

If the rest time of a container 200 is long, particles in a stored liquid are sedimented in a part of the container 200. If the sedimented particles stick to the part of the container 200, it is difficult to obtain evenness of the liquid by the stirring operation, or a long time is needed to obtain evenness. However, progress of particle sedimentation can be suppressed by repetitively changing the posture of the container 200. On the other hand, the sedimentation speed of the particles in the liquid changes depending on the particle size, and the degree of local concentration of the particles in the container 200 also changes depending on the posture of the container 200.

In this embodiment, in the rotation operation of the container 200, rotation of a storage unit 110 is temporarily stopped at a plurality of stop positions to promote diffusion of particles, and a stop time is individually set for each stop position, thereby suppressing progress of sedimentation. This makes it possible to efficiently stir the liquid in the container 200 and maintain evenness.

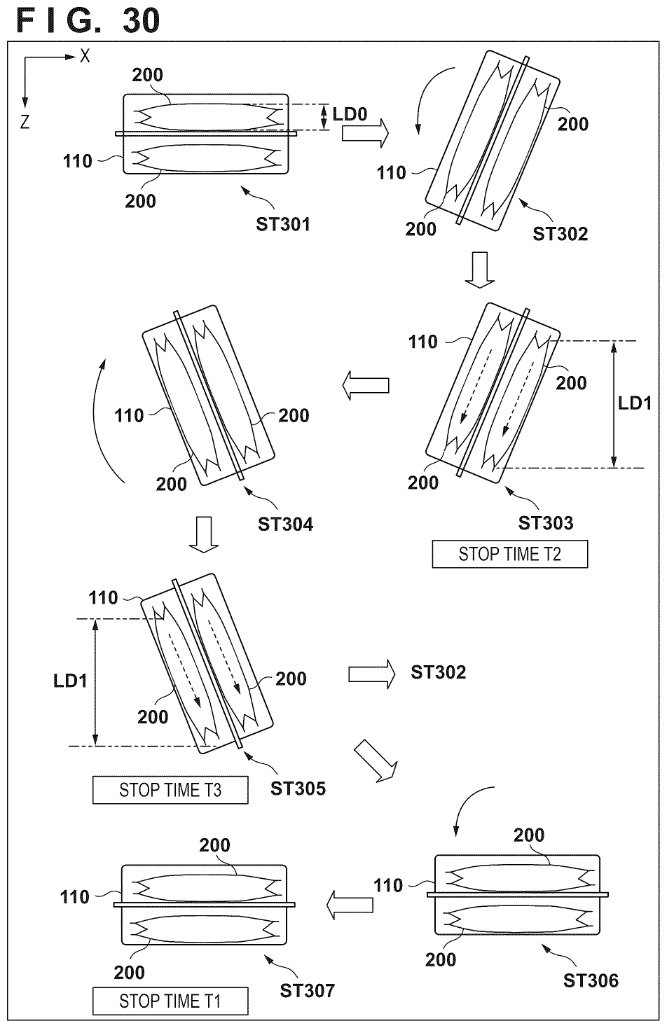

FIG. 30 is an operation explanatory view showing an example of a stirring operation (a rotation operation of the storage unit 110) according to this embodiment. A state ST301 indicates a state in which the storage unit 110 is at the initial position. The liquid depth in the container 200 is LD0. The storage unit 110 is rotated counterclockwise from the state ST301 to the left tilting position (state ST302). The left tilting position is set to one of stop positions, and the storage unit 110 is stopped for time T2, as indicated by a state ST303. The liquid depth in the container 200 is LD1 (>LD0).

After the elapse of the time T2, rotation of the storage unit 110 is resumed. The storage unit 110 is rotated clockwise from the state ST303 to the right tilting position (state ST304). The right tilting position is set to one of the stop positions, and the storage unit 110 is stopped for time T3, as indicated by a state ST305. The liquid depth in the container 200 is LD1 (>LD0).

After the elapse of the time T3, rotation of the storage unit 110 is resumed. The storage unit 110 is rotated counterclockwise from the state ST305 to the left tilting position. The state of the storage unit 110 returns to the state ST302. The operation from the state ST302 to the state ST305 is repeated a predetermined number of times.

After the operation from the state ST302 to the state ST305 is repeated a predetermined number of times, the storage unit 110 is rotated counterclockwise from the state ST305 to the initial position. The initial position is set to one of the stop positions, and the storage unit 110 is stopped for time T1, as indicated by a state ST307.

After the stop for the time T1, the above-described operation from the state ST301 to the state ST307 is repeated until the end condition of the stirring operation is satisfied. The end condition is, for example, that the user instructs an end, that a predetermined time has elapsed from the start of the stirring operation, or that a predetermined end time is reached. As long as the power of a liquid storage apparatus 20A is ON, the evenness of the liquid in the container 200 can be maintained by continuing the stirring operation shown in FIG. 30, and the stirring operation shown in FIG. 30 can be continued even in a sleep state of a liquid discharge apparatus 1 (printing operation stop state).

The relationships of the liquid depths in the container 200 and the stop times T1 to T3 will be described. The liquid depths in the container 200 hold a relationship given by LD1>LD0, although it changes depending on the remaining amount. The liquid depth in the container 200 in a case where the container 200 is at the left tilting position or right tilting position (LD1) is deeper than that in a case where the container 200 is at the initial position (LD0). If the liquid depth is deep, diffusion and sedimentation of particles tend to be promoted by gravity, as compared to a case where the depth is shallow. If the container 200 is at the initial position, it is advantageous in the viewpoint of suppressing progress of sedimentation, although the particles poorly diffuse. To the contrary, if the container 200 is at the left tilting position or right tilting position, it is advantageous in the viewpoint of diffusion of the particles, but suppression of the progress of sedimentation is poor. Hence, the stop times T2 and T3 at the left tilting position and the right tilting position are set shorter than the stop time T1 at the initial position (T2<T1, and T3<T1). Also, when the stop time T1 is set relatively long, it is possible to prevent unnecessary rotation and reduce power consumption.

The stop times T2 and T3 may be, for example, times in the range of 30 sec to 3 min and, particularly, times in the range of 1 min to 2 min. The stop time T2 and the stop time T3 may be equal or different. The stop time T2 and the stop time T3 may be change during the repetition of the operation from the state ST302 to the state ST305 a predetermined number of times. For example, T2>T3 may be set in odd-numbered operations, and T3>T2 may be set in even-numbered operations.

The stop time T1 may be, for example, a time in the range of 5 min to 40 min, particularly, a time in the range of 15 min to 30 min and, furthermore, a time in the range of 20 min to 25 min. If the stop time T1 is exemplified by a relationship of multiple to the stop time T2 or T3, 10·T2≤T1≤20·T2, and 10·T3≤T1≤20·T3 may hold.

The count of repeating the operation from the state ST302 to the state ST305 may be, for example, a count in the range of three times to 15 times and, particularly, a count in the range of six times to 10 times. The rotation speed of the storage unit 110 may be a speed selected from the range of 20 deg/sec or more and 40 deg/sec or less and, particularly, a speed selected from the range of 25 deg/sec or more and 35 deg/sec or less. A more specific speed may be 30 deg/sec.

The example in FIG. 30 exemplarily shows the left tilting position, the right tilting position, and the initial position as the stop positions of the storage unit 110. Since the initial position is a position between the left tilting position and the right tilting position in the rotation direction of the storage unit 110, the posture of the storage unit 110 is an intermediate posture. The above-described effects can readily be obtained by making the stop time at the initial position longer than that at the left tilting position or the right tilting position.

Note that the example in FIG. 30 exemplarily shows the left tilting position, the right tilting position, and the initial position as the stop positions of the storage unit 110, but the stop positions are not limited to these. In place of the left tilting position, a position slightly closer to the initial position than the left tilting position (a position where the tilt angle with respect to the horizontal direction is small) may be set to the stop position. Similarly, in place of the right tilting position, a position slightly closer to the initial position than the right tilting position (a position where the tilt angle with respect to the horizontal direction is small) may be set to the stop position. Furthermore, in place of the initial position, a position slightly closer to the left tilting position than the initial position or a position slightly closer to the right tilting position may be set to the stop position, or the two positions may alternately be selected as the stop position.

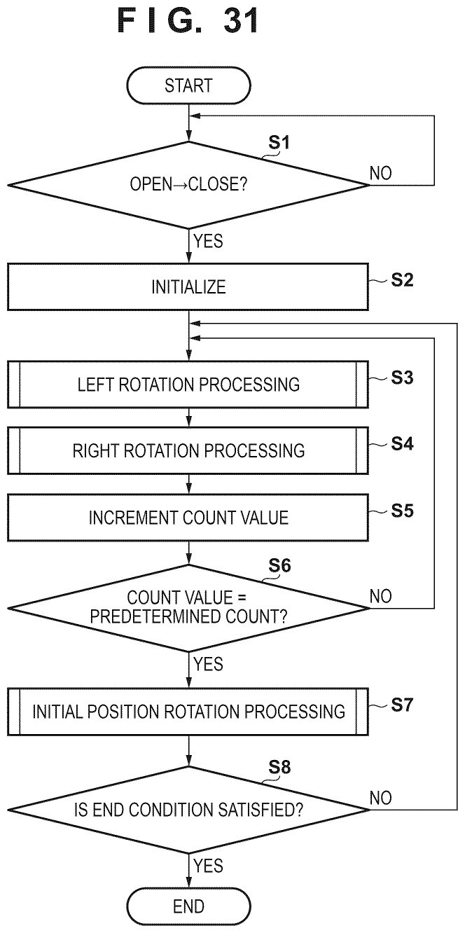

An example of processing of a control unit 32 that controls the operation shown in FIG. 30 will be described next. FIG. 31 is a flowchart showing an example of processing of the control unit 32.

In step S1, the detection result of a sensor 26 is acquired, and it is determined whether an opening/closing member 25 changes from an open state to a closed state. Upon determining that the opening/closing member 25 changes from an open state to a closed state, it is considered that exchange of the container 200, or the like is performed, and the process advances to step S2 to start the stirring operation. Note that the start condition of the stirring operation may be, for example, that a predetermined stirring start time is reached, or that the elapsed time from the preceding stirring operation is a predetermined time.

In step S2, initialization processing is executed. Here, processing of rotating the storage unit 110 to the initial position, which has been described with reference to FIG. 18, is executed.

In step S3, left rotation processing of rotating the storage unit 110 to the left tilting position and stopping it (the states ST302 and ST303 in FIG. 30) is executed. Details will be described later. In step S4, right rotation processing of rotating the storage unit 110 to the right tilting position and stopping it (the states ST304 and ST305 in FIG. 30) is executed. Details will be described later.

In step S5, the count value of the repetition count of left rotation processing and right rotation processing is incremented by one. In step S6, it is determined whether the count value reaches a predetermined count. Upon determining that the count value reaches the predetermined count, the count value is reset, and the process advances to step S7. Upon determining that the count value has not reached the predetermined count, the process returns to step S3.

In step S7, initial position rotation processing of rotating the storage unit 110 to the initial position and stopping it (the states ST306 and ST307 in FIG. 30) is executed. Details will be described later. In step S8, it is determined whether the end condition of the stirring operation is satisfied. Upon determining that the end condition is not satisfied, the process returns to step S3. Upon determining that the end condition is satisfied, the stirring operation is ended.

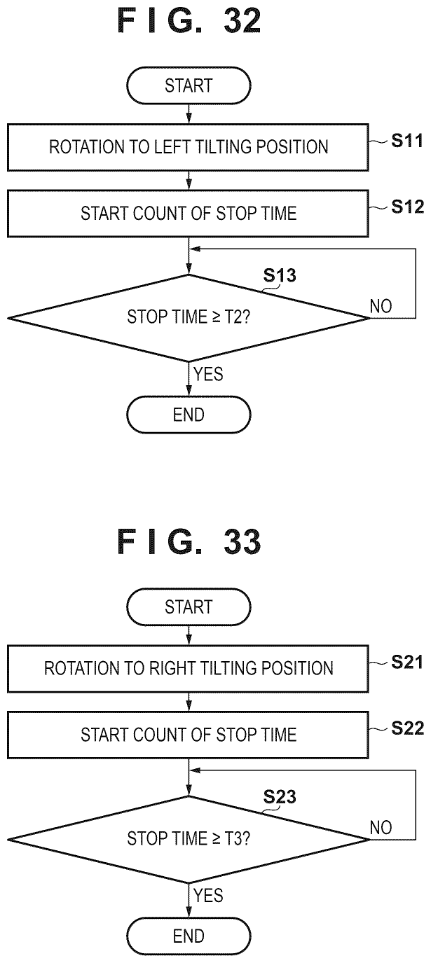

FIG. 32 is a flowchart showing an example of left rotation processing in step S3. In step S11, a motor 131 is driven, and processing of rotating the storage unit 110 to the left tilting position and stopping it is executed. At the time of stop, to prevent the storage unit 110 from rotating even if an external force is applied, a weak excitation voltage may be applied such that the motor 131 generates a holding torque. In step S12, count of the stop time is started. In step S13, it is determined whether the stop time started in step S12 is equal to or more than T2, and if the stop time is T2 or more, the processing is ended.

FIG. 33 is a flowchart showing an example of right rotation processing in step S4. In step S21, the motor 131 is driven, and processing of rotating the storage unit 110 to the right tilting position and stopping it is executed. At the time of stop, to prevent the storage unit 110 from rotating even if an external force is applied, a weak excitation voltage may be applied such that the motor 131 generates a holding torque. In step S22, count of the stop time is started. In step S23, it is determined whether the stop time started in step S22 is equal to or more than T3, and if the stop time is T3 or more, the processing is ended.

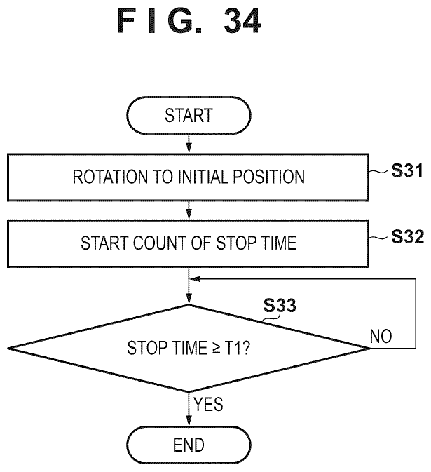

FIG. 34 is a flowchart showing an example of initial position rotation processing in step S7. In step S31, the motor 131 is driven, and processing of rotating the storage unit 110 to the initial position and stopping it is executed. At the time of stop, to prevent the storage unit 110 from rotating even if an external force is applied, a weak excitation voltage may be applied such that the motor 131 generates a holding torque. In step S32, count of the stop time is started. In step S33, it is determined whether the stop time started in step S32 is equal to or more than T1, and if the stop time is T1 or more, the processing is ended.

### Fourth Embodiment

In the third embodiment, an operation has been exemplified in which in the stirring operation, an operation of rotating the container 200 between the left tilting position and the right tilting position a plurality of times and then rotating the container 200 to the initial position is performed a plurality of times. The stirring operation may be, for example, an operation of performing, a plurality of times, an operation of rotating the container 200 between the left tilting position (or the right tilting position) and the initial position a plurality of times and then stopping the container 200 at the initial position.

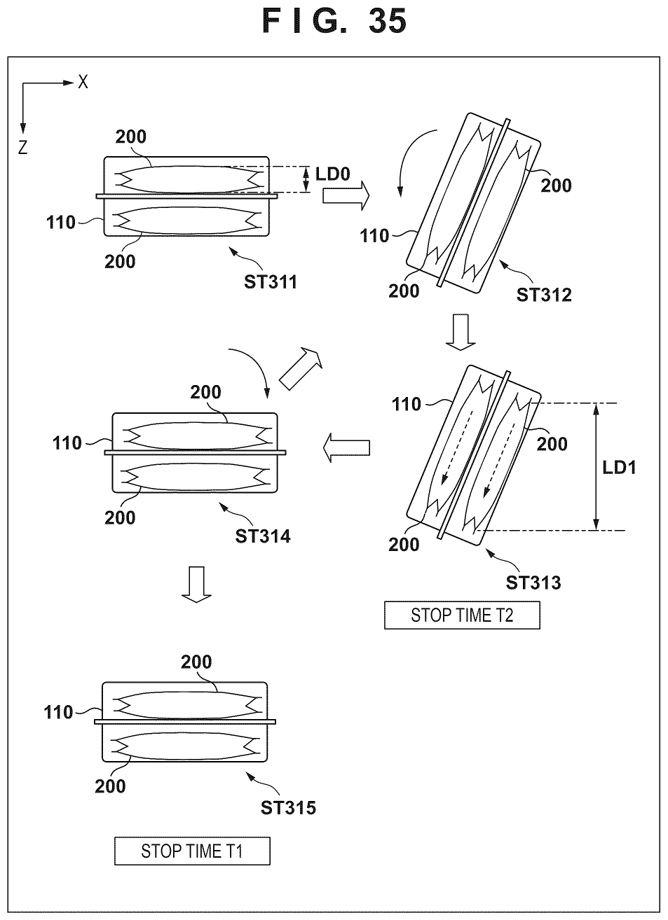

FIG. 35 shows an example of a stirring operation of performing, a plurality of times, an operation of rotating a container 200 between the left tilting position and the initial position a plurality of times and then rotating the container 200 to the initial position. Points different from the third embodiment will be described.

A state ST311 indicates a state in which a storage unit 110 is at the initial position. The liquid depth in a container 200 is LD0. The storage unit 110 is rotated counterclockwise from the state ST311 to the left tilting position (state ST312). This position is set to one of stop positions, and the storage unit 110 is stopped for time T2, as indicated by a state ST313. The liquid depth in the container 200 is LD1 (>LD0).

After the elapse of the time T2, rotation of the storage unit 110 is resumed. The storage unit 110 is rotated clockwise from the state ST313 to the initial position (state ST314). This position is not set to one of the stop positions, and the storage unit 110 is immediately rotated counterclockwise to the left tilting position (state ST312). After the operation from the state ST312 to the state ST314 is repeated a plurality of times, the initial position is set to one of the stop positions, and the storage unit 110 is stopped for time T1, as indicated by a state ST315. The repetition count of the operation from the state ST312 to the state ST314 may be, for example, a count in the range of six times to 30 times and, particularly, a count in the range of 12 times to 20 times.

After the stop for the time T1, the above-described operation from the state ST311 to the state ST315 is repeated until the end condition of the stirring operation is satisfied.

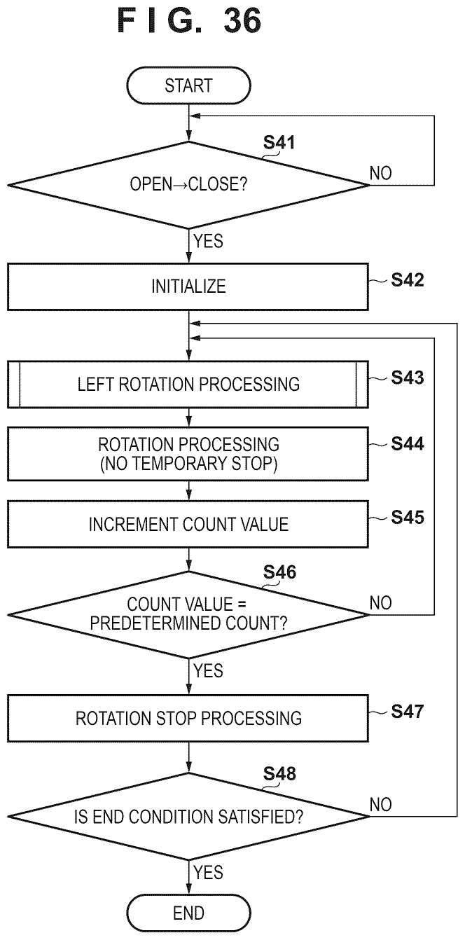

An example of processing of a control unit 32 that controls the operation shown in FIG. 35 will be described. FIG. 36 is a flowchart showing an example of processing of the control unit 32.

In step S41, the detection result of a sensor 26 is acquired, and it is determined whether an opening/closing member 25 changes from an open state to a closed state. Upon determining that the opening/closing member 25 changes from an open state to a closed state, it is considered that exchange of the container 200, or the like is performed, and the process advances to step S42 to start the stirring operation. Note that the start condition of the stirring operation may be, for example, that a predetermined stirring start time is reached, or that the elapsed time from the preceding stirring operation is a predetermined time.

In step S42, initialization processing is executed. Here, processing of rotating the storage unit 110 to the initial position, which has been described with reference to FIG. 18, is executed. In step S43, left rotation processing of rotating the storage unit 110 to the left tilting position and stopping it (the states ST312 and ST313 in FIG. 35) is executed. This is the same processing as the processing shown in FIG. 32.

In step S44, rotation processing of rotating the storage unit 110 to the initial position (the state ST314 in FIG. 35) is executed. This processing is processing of driving a motor 131 and rotating the storage unit 110 to the initial position.

In step S45, the count value of the repetition count of left rotation processing is incremented by one. In step S46, it is determined whether the count value reaches a predetermined count. Upon determining that the count value reaches the predetermined count, the count value is reset, and the process advances to step S47. Upon determining that the count value has not reached the predetermined count, the process returns to step S43.

In step S47, rotation stop processing of stopping the storage unit 110 at the initial position (the state ST315 in FIG. 35) is executed. In this processing, the stop time is counted, and if the stop time is equal to or more than T1, the processing is ended. During the stop, to prevent the storage unit 110 from rotating even if an external force is applied, a weak excitation voltage may be applied such that the motor 131 generates a holding torque.

In step S48, it is determined whether the end condition of the stirring operation is satisfied. Upon determining that the end condition is not satisfied, the process returns to step S43. Upon determining that the end condition is satisfied, the stirring operation is ended.

Note that in this embodiment, a stirring operation of performing, a plurality of times, an operation of rotating the container 200 between the left tilting position and the initial position a plurality of times and then stopping the container 200 at the initial position has been exemplified. However, the stirring operation may be an operation of performing, a plurality of times, an operation of rotating the container 200 between the right tilting position and the initial position a plurality of times and then stopping the container 200 at the initial position. Alternatively, a stirring operation of stopping the storage unit 110 at the left tilting position and a stirring operation of stopping the storage unit 110 at the right tilting position may alternately be performed, like the example shown in FIG. 35.

In this embodiment, in the state ST314, the storage unit 110 is not temporarily stopped at the initial position and immediately rotated to the left tilting position. However, the storage unit 110 may be stopped for a predetermined time (T1A). The relationship between the time T1A and the time T1 may be given by time T1>time T1A. Also, the relationship between the time T1A and the time T2 may be given by time T1A>time T2.

### Fifth Embodiment

In the third embodiment or the fourth embodiment, stop times T1 to T3 may changeably be set in accordance with the state of the apparatus or the state of a container 200.

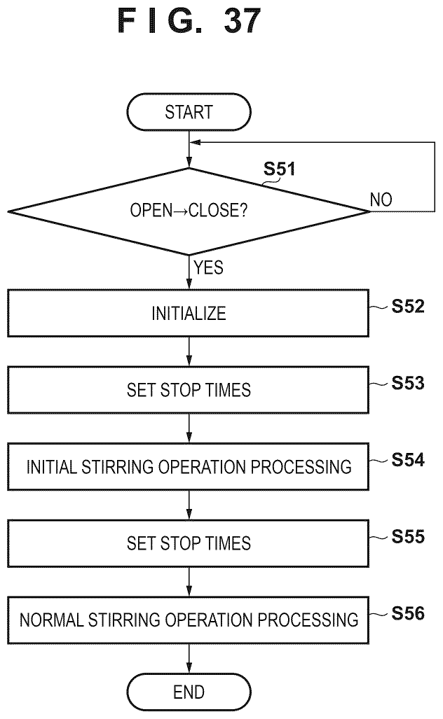

FIG. 37 is a flowchart showing an example of processing executed by a control unit 32. In this example of processing, if the container 200 is exchanged, an initial stirring operation of strongly stirring a liquid is performed, and after that, a normal stirring operation is performed. In a liquid stored in a new container 200, sedimentation of particles sometimes progresses due to storage of the container 200 for a long time. Hence, the liquid is strongly stirred at the time of exchange of the container 200, thereby promoting elimination of sedimentation of the particles.

In step S51, the detection result of a sensor 26 is acquired, and it is determined whether an opening/closing member 25 changes from an open state to a closed state. Upon determining that the opening/closing member 25 changes from an open state to a closed state, it is considered that exchange of the container 200, or the like is performed, and the process advances to step S52 to start the stirring operation. In step S52, initialization processing is executed. Here, processing of rotating the storage unit 110 to the initial position, which has been described with reference to FIG. 18, is executed.

In step S53, the stop times T1 to T3 to be used in the initial stirring operation are set. The stop times T1, T2, and T3 to be set here are defined as T11, T21, and T31.

In step S54, initial stirring operation processing is executed. The contents of the initial stirring operation processing are the same as, for example, those of the stirring operation of the third embodiment (steps S3 to S8 in FIG. 31) or the fourth embodiment (steps S43 to S48 in FIG. 36). However, as the stop times T1 to T3, the stop times T11, T21, and T31 set in step S53 are used. The end condition (steps S8 and S48) of the stirring operation may be, for example, the elapse of a predetermined time. The predetermined time may be, for example, a time in the range of 5 min to 40 min, particularly, a time in the range of 5 min to 20 min. The end condition of the stirring operation may also be that the count of the stirring operation reaches a predetermined count. The count of the stirring operation is the repetition count of steps S2 to S7 in the example of FIG. 31, and is the repetition count of steps S43 to S47 in the example of FIG. 36. The predetermined time may be, for example, a count in the range of 10 times to 30 times.

When the initial stirring operation processing is ended, in step S55, the stop times T1 to T3 to be used in a normal stirring operation after that are set. The stop times T1, T2, and T3 to be set here are defined as stop times T12, T22, and T32. In step S56, normal stirring operation processing is performed. The contents of the normal stirring operation processing are the same as, for example, those of the stirring operation of the third embodiment (steps S3 to S8 in FIG. 31) or the fourth embodiment (steps S43 to S48 in FIG. 36). However, as the stop times T1 to T3, the stop times T12, T22, and T32 set in step S55 are used.

Here, when the stop times T1 to T3 in the initial stirring operation and those in the normal stirring operation are compared, T11<T12, T21<T22, and T31<T32 hold. Since the stirring count per unit time increases in the initial stirring operation, the liquid in the container 200 can be stirred more strongly. When the stop times T1 to T3 are indicated by ranges, for example, ¼·T12≤T11≤¾·T12, particularly, ⅓·T12≤T11≤⅔·T12 may hold. Similarly, ¼·T22≤T21≤¾·T22, particularly, ⅓·T22≤T21≤⅔·T22 may hold. Similarly, ¼·T32≤T31≤¾·T32, particularly, ⅓·T32≤T31≤⅔·T32 may hold.

Also, the rotation speed of the storage unit 110 may be changed between the initial stirring operation and the normal stirring operation. For example, letting V1 be the rotation speed of the initial stirring operation, and V2 be the rotation speed of the normal stirring operation, V1>V2 may hold. V1 is, for example, 140 deg/sec, and V2 is, for example, 30 deg/sec.

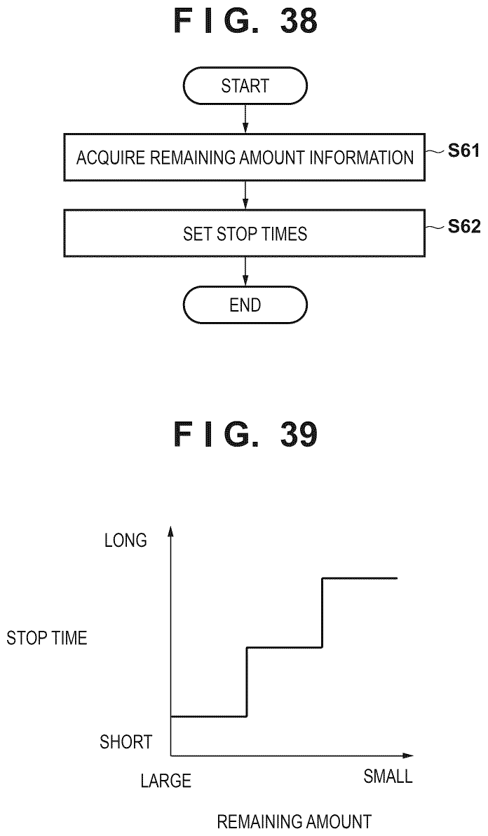

Another setting example of the stop times will be described next. FIG. 38 is a flowchart showing an example of processing executed by the control unit 32, and is particularly a flowchart showing an example of stop time updating processing. This processing is repetitively performed halfway through the stirring operation according to the third or fourth embodiment or during execution of the normal stirring operation processing in step S56 of FIG. 37.

When the remaining amount of the liquid in the container 200 decreases, fluidity lowers because the liquid flows while extending the container 200. That is, the moving speed of the particles in the liquid lowers, and diffusability lowers. In this embodiment, the stop times T1 to T3 are updated to longer times in accordance with the decrease of the remaining amount of the liquid in the container 200.

In step S61 in FIG. 38, the information of the remaining amount (remaining amount information) of the liquid in the container 200 is acquired. In this embodiment, two containers 200 are stored in the storage unit 110. Hence, remaining amount information is acquired for each container 200. For example, concerning the liquid stored in the container 200, the remaining amount information may be the amount (the counted number of dots) of the liquid discharged from a discharge head 8 of a liquid discharge apparatus 1. In this case, the remaining amount information may be acquired, via a main control unit 30, from a control unit 31 that controls the liquid discharge apparatus 1. Alternatively, a remaining amount sensor may be provided in the container 200, and the detection value of the remaining amount sensor may be used as the remaining amount information.

In step S62, the stop times T1 to T3 are set based on the remaining amount information acquired in step S61. In this embodiment, since two containers 200 are stored in the storage unit 110, the stop times T1 to T3 are set based on the smallest remaining amount in each remaining amount information as a reference.

FIG. 39 is a view showing an example of a stop time setting table. In the example shown in FIG. 39, the stop time is defined such that the stop time becomes long stepwise in accordance with a decrease of the remaining amount. Such a table is prepared for each of the stop times T1, T2, and T3 and referred to. A common table may be prepared for the stop time T2 and the stop time T3. Note that the stop time T1 may be set constant without being updated depending on the remaining amount of the liquid, and the stop times T2 and T3 associated with the tilting position where diffusion of particles is expected may be changed in accordance with the remaining amount of the liquid.

### Sixth Embodiment

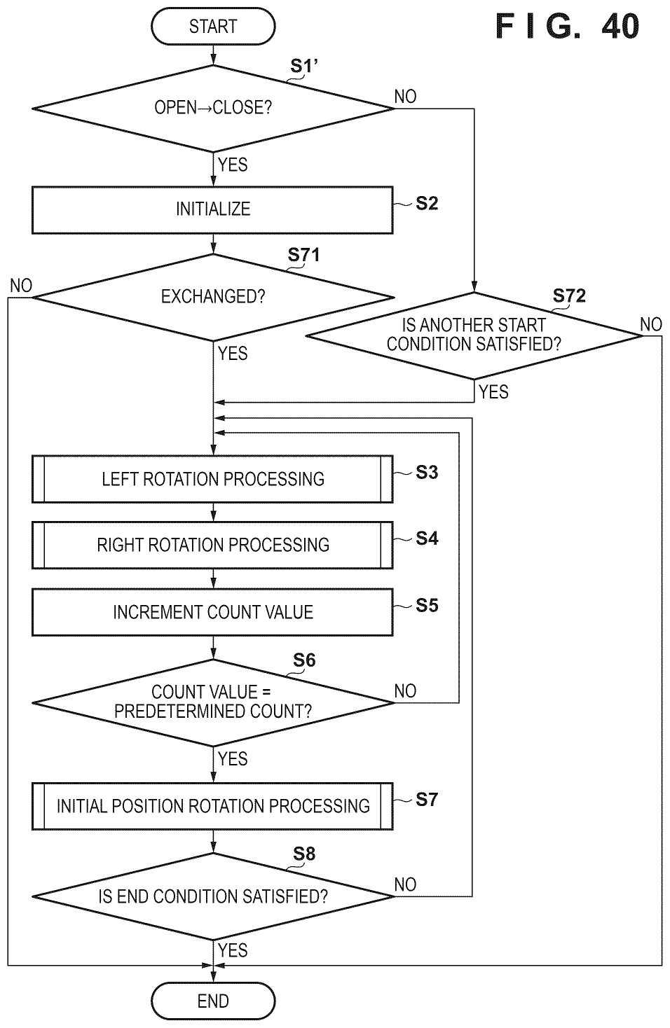

In the processing example shown in FIG. 31, if it is determined that the opening/closing member 25 changes from the open state to the closed state, it is considered that exchange of the container 200, or the like is performed. However, a stirring operation may be started by determining whether the container 200 is exchanged. Also, processing in FIG. 31 shows control of starting the stirring operation in accordance with the state change of the opening/closing member 25. However, even if there is no state change of the opening/closing member 25, the stirring operation may be started if another start condition is satisfied. FIG. 40 is a flowchart showing an example of processing according to this embodiment. Processing different from the example shown in FIG. 31 will be described.

In step S1′ replacing step S1 of FIG. 31, upon determining that an opening/closing member 25 changes from an open state to a closed state, the process advances to step S2. Upon determining that the opening/closing member 25 does not change from an open state to a closed state, the process advances to step S72.

After step S2, in step S71, it is determined whether a container 200 is exchanged. For example, a sensor that detects the presence/absence of the container 200 may be provided in a storage space 114, and it may be determined, based on the detection result of the sensor, whether the container 200 is exchanged. More specifically, if the detection result of the sensor changes from “no container 200” to “container 200” during the open state of the opening/closing member 25, it may be determined that the container 200 is exchanged. The sensor may be an optical sensor.

Upon determining in step S2 that the container 200 is exchanged, the process advances to step S3. Upon determining that the container 200 is not exchanged, the processing is ended.

In step S72, it is determined whether another start condition of the stirring operation is satisfied. Another start condition may be, for example, that a predetermined stirring start time is reached, or that the elapsed time from the preceding stirring operation is a predetermined time. Upon determining that another start condition is satisfied, the process advances to step S3. Upon determining that another start condition is not satisfied, the processing is ended.

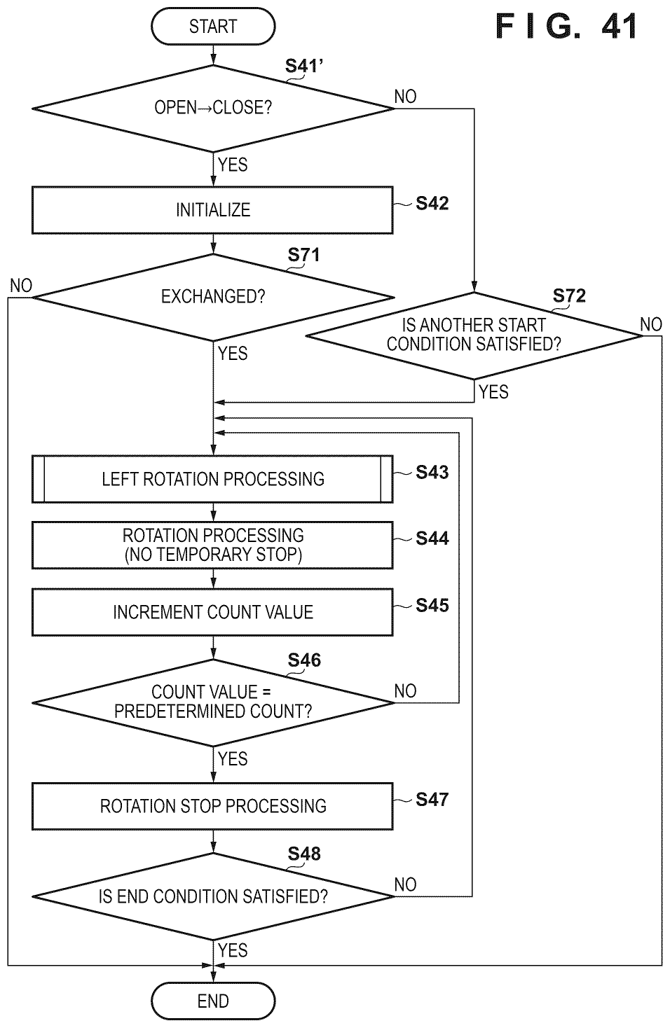

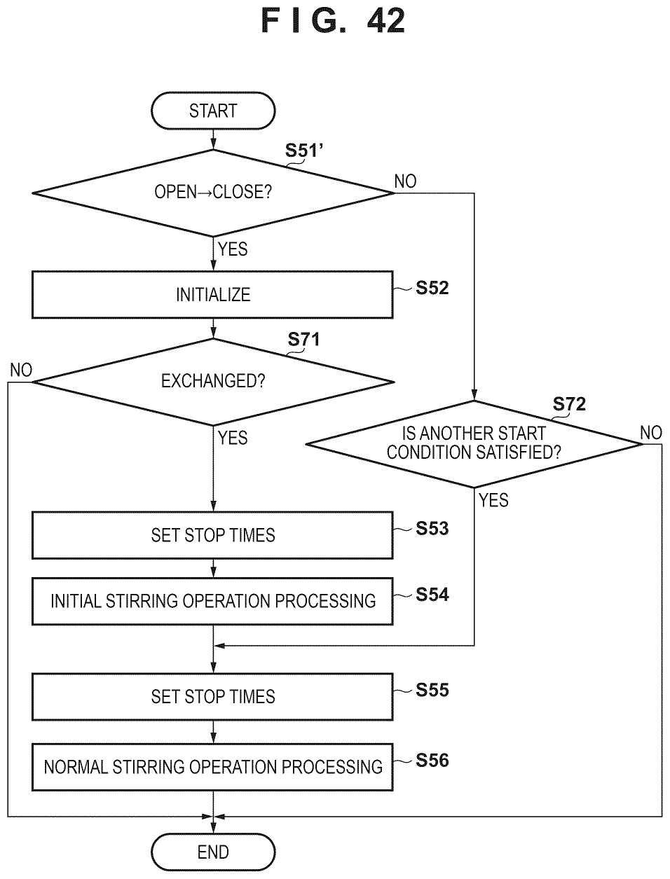

The example of processing according to this embodiment can be applied to the example of processing shown in FIG. 36 or 37. FIG. 41 shows an example of processing obtained by applying this embodiment to the example of processing shown in FIG. 36.

In step S41′ replacing step S41 of FIG. 36, upon determining that the opening/closing member 25 changes from the open state to the closed state, the process advances to step S42. Upon determining that the opening/closing member 25 does not change from the open state to the closed state, the process advances to step S72. After step S42, in step S71, it is determined whether the container 200 is exchanged. Upon determining that the container 200 is exchanged, the process advances to step S43. Upon determining that the container 200 is not exchanged, the processing is ended. In step S72, it is determined whether another start condition of the stirring operation is satisfied. Upon determining that another start condition is satisfied, the process advances to step S43. Upon determining that another start condition is not satisfied, the processing is ended.

FIG. 42 shows an example of processing obtained by applying this embodiment to the example of processing shown in FIG. 37. In step S51′ replacing step S51 of FIG. 37, upon determining that the opening/closing member 25 changes from the open state to the closed state, the process advances to step S52. Upon determining that the opening/closing member 25 does not change from the open state to the closed state, the process advances to step S72. After step S52, in step S71, it is determined whether the container 200 is exchanged. Upon determining that the container 200 is exchanged, the process advances to step S53. Upon determining that the container 200 is not exchanged, the processing is ended. In step S72, it is determined whether another start condition of the stirring operation is satisfied. Upon determining that another start condition is satisfied, the process advances to step S55. Upon determining that another start condition is not satisfied, the processing is ended.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-072923, filed Apr. 26, 2024, which is hereby incorporated by reference herein in its entirety.

What is claimed is:

1. A liquid stirring apparatus comprising:
a storage unit configured to store a liquid; and
a driving unit configured to perform a rotation operation of rotating the storage unit,
wherein the rotation operation includes a stop operation of stopping rotation of the storage unit at a plurality of stop positions, and
the plurality of stop positions include:
a first stop position at which a stop time is a first time; and
a second stop position at which the stop time is a second time different from the first time.

2. The liquid stirring apparatus according to claim 1, wherein
a posture of the storage unit at the second stop position is a posture in which a liquid depth of the liquid stored in the storage unit is deeper than in the posture of the storage unit at the first stop position, and
the second time is shorter than the first time.

3. The liquid stirring apparatus according to claim 1, wherein
the plurality of stop positions include
a third stop position at which the stop time is a third time different from the first time, and
in a rotation direction of the storage unit, the first stop position is a position between the second stop position and the third stop position.

4. The liquid stirring apparatus according to claim 3, wherein
the rotation operation is an operation of repeating an operation of rotating the storage unit a plurality of times between the second stop position and the third stop position and then stopping the storage unit at the first stop position.

5. The liquid stirring apparatus according to claim 1, wherein
the storage unit stores a container in which the liquid is stored,
the container is in a horizontal posture at the first stop position, and
the container is in a tilting posture at the second stop position.

6. The liquid stirring apparatus according to claim 1, further comprising
a setting unit configured to set the stop time.

7. The liquid stirring apparatus according to claim 6, further comprising
an acquisition unit configured to acquire information of a remaining amount of the liquid in the storage unit,
wherein the setting unit sets the stop time based on the information of the remaining amount.

8. The liquid stirring apparatus according to claim 7, wherein
in a case where the remaining amount is small, the setting unit sets the second time longer than in a case where the remaining amount is large.

9. The liquid stirring apparatus according to claim 7, wherein
the storage unit stores a plurality of liquid containers, and
the setting unit sets the stop time based on, as a reference, a remaining amount in a liquid container in which the remaining amount is smallest among the plurality of liquid containers.

10. The liquid stirring apparatus according to claim 6, wherein
the storage unit exchangeably stores a liquid container,
if the liquid container is exchanged, after a first rotation operation is performed by the driving unit as the rotation operation, a second rotation operation is performed, and
the first rotation operation is an operation of setting, by the setting unit, at least one of the first time and the second time shorter than in the second rotation operation.

11. The liquid stirring apparatus according to claim 1, wherein
the storage unit comprises a storage member configured to form a storage space for exchangeably storing a liquid container, and includes one end portion and the other end portion in a direction of a rotational centerline of the storage unit,
the storage space opens to the one end portion, and
a channel forming member communicating with the liquid container and configured to form a channel for flowing the liquid to an outside is provided at the other end portion.

12. The liquid stirring apparatus according to claim 11, wherein
the channel forming member is provided with a valve unit configured to open/close the channel.

13. A system including a liquid discharge apparatus which discharges a liquid to a medium, and a liquid storage apparatus which stores the liquid to be supplied to the liquid discharge apparatus, wherein
the liquid storage apparatus includes a liquid stirring apparatus,
the liquid stirring apparatus comprises:
a storage unit configured to store a liquid; and
a driving unit configured to perform a rotation operation of rotating the storage unit,
the rotation operation includes a stop operation of stopping rotation of the storage unit at a plurality of stop positions, and
the plurality of stop positions include:
a first stop position at which a stop time is a first time; and
a second stop position at which the stop time is a second time different from the first time.

14. A control method of a liquid stirring apparatus including:
a storage unit configured to store a liquid; and
a driving unit configured to rotate the storage unit, comprising:
rotating the storage unit by the driving unit,
wherein the rotating includes stopping rotation of the storage unit at a plurality of stop positions, and
the plurality of stop positions include:
a first stop position at which a stop time is a first time; and
a second stop position at which the stop time is a second time different from the first time.
